(19) United States
(12) Patent Application Publication
(10) Pub. No.: US 2026/0281235 A1
(43) Pub. Date: Sep. 17, 2026

(54) SYSTEM

(71) Applicant: SoftBank Group Corp., Tokyo (JP)

(72) Inventor: Kazuhiko MIGITA, Tokyo (JP)

(73) Assignee: SoftBank Group Corp., Tokyo (JP)

(21) Appl. No.: 19/553,482

(22) Filed: Mar. 2, 2026

Related U.S. Application Data
(60) Provisional application No. 63/771,301, filed on Mar. 13, 2025.

(51) Int. Cl. H04M 3/22; G06F 40/284; G06F 40/289; G10L 13/033; G10L 17/02; G10L 17/18; G10L 17/22; G10L 17/26; G10L 25/63

(52) U.S. Cl. CPC H04M 3/2281; G06F 40/284; G06F 40/289; G10L 13/033; G10L 17/02; G10L 17/18; G10L 17/22; G10L 17/26; G10L 25/63

(57) ABSTRACT

A system includes a processor that is configured to: receive, in real time, audio data of a telephone call or a voice message from a user, and convert the audio data into text data by using a speech recognition technique; analyze the text data by using a natural language processing technique to detect keywords or phrases indicating a possibility of fraud; compare the text data with a past fraud case database, and perform scoring of an abnormality based on a result of the comparison; and generate, based on an analysis result, an appropriate response for probing a possibility of fraud and provide the appropriate response to the user as a proposed response or automatically perform an agent response using the appropriate response.

### CROSS-REFERENCE TO RELATED APPLICATION

This application is based on and claims priority under 35 USC 119(e) from U.S. Provisional Application No. 63/771,301 filed on Mar. 13, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional telephone and voice-based communication systems lack effective real-time mechanisms to detect and mitigate fraud attempts during ongoing interactions. In many cases, a user receives a suspicious call or voice message in which a caller requests money transfers, personal information, or confidential authentication data by exploiting urgency, fear, or confusion. Existing technologies may provide static spam lists or caller identification, but they do not dynamically analyze the actual conversation content, do not continuously update a fraud risk assessment as the interaction progresses, and do not generate context-appropriate responses that help the user safely probe the caller's intent. As a result, users are often unable to recognize sophisticated or novel fraud patterns in time and may inadvertently comply with fraudulent requests. Furthermore, conventional systems do not provide integrated support that combines speech recognition, natural language analysis, response generation, and speech synthesis to enable seamless, real-time intervention during a live call. Accordingly, there is a need for a system that can automatically convert received audio into text, analyze the text to detect fraud indicators, score and update a fraud risk level, generate safe and appropriate responses, and assist the user by providing such responses as suggestions or performing agent responses, while also issuing warnings and blocking interactions when high fraud risk is detected.

### SUMMARY

To solve the above-described problems, the invention provides a system comprising a processor configured to perform integrated processing of audio reception, text analysis, response generation, and safety evaluation. The processor is configured to receive, in real time, audio data of a telephone call or a voice message from a user and convert the audio data into text data by using a speech recognition technique. The processor is configured to analyze the resulting text data by using a natural language processing technique, detect keywords or phrases indicating a possibility of fraud, compare the text data with a past fraud case database, and perform scoring of an abnormality based on a result of the comparison. The processor is further configured to generate, based on an analysis result, an appropriate response for probing a possibility of fraud and provide the appropriate response to the user as a proposed response or automatically perform an agent response using the appropriate response. In one embodiment, the processor is configured to perform a telephone response by using a speech synthesis technique, convert the generated response into natural speech so as not to give an unnatural impression to a counterpart, and cooperate with the reception of the audio data to enable real-time response, wherein the generated response content includes questions for confirming an intention of the counterpart and additional confirmation items that are carefully designed to probe the possibility of fraud. In another embodiment, the processor is configured to continuously evaluate safety during an interaction by updating a score based on newly detected information and adjusting response content as needed, and to notify a user when a possibility of fraud is finally determined to be low by providing details of the interaction, while issuing a warning and blocking the interaction when a possibility of fraud is determined to be high so as to protect the user. Through these means, the system reduces fraud risk during telephone and voice-based communications and enhances the safety and confidence of the user.

The term “system” refers to an arrangement of one or more hardware and software components that operate together to perform the functions described in the claims, including at least one processor configured to execute programmed instructions.

The term “processor” refers to any hardware device or combination of hardware devices capable of executing instructions, including but not limited to a central processing unit (CPU), a microprocessor, a digital signal processor (DSP), a microcontroller, a programmable logic device, or a combination thereof, whether implemented in a server, a terminal, or any other computing apparatus.

The term “audio data” refers to digital or analog representations of sound signals, including voice signals obtained from telephone calls, voice messages, or other voice communication channels, which can be processed by the processor.

The term “telephone call” refers to a real-time bidirectional or unidirectional voice communication session between at least two parties, established over a public switched telephone network, a mobile network, or an Internet protocol-based communication network. The term “voice message” refers to a recorded audio communication, such as a voicemail, an audio clip, or a message sent via a voice messaging application, which can be replayed and processed by the system.

The term “speech recognition technique” refers to any algorithm, model, or software that converts audio data containing human speech into corresponding text data, including but not limited to automatic speech recognition (ASR) systems based on statistical models, neural networks, or hybrid approaches.

The term “text data” refers to a sequence of characters, words, sentences, or other textual representations that are obtained by converting audio data using a speech recognition technique or by any other input method, and that are analyzable by natural language processing.

The term “natural language processing technique” refers to any computational method or model for analyzing, interpreting, or processing human language text, including but not limited to tokenization, parsing, semantic analysis, intent detection, keyword extraction, and machine learning-based language models.

The term “keyword” refers to a word or a set of words occurring in the text data that is predetermined or learned to be indicative of a certain meaning, context, or condition, such as a potential fraud attempt.

The term “phrase” refers to a group of two or more words that together convey a particular meaning or intent and are treated as a unit for purposes of fraud detection, such as phrases expressing urgency or requests for money transfers.

The term “possibility of fraud” refers to a likelihood, risk level, or probability that a given communication, message, or interaction is related to a fraudulent attempt, scam, or deceptive activity aimed at exploiting the user.

The term “past fraud case database” refers to one or more data stores containing records of known or suspected fraud incidents, including associated texts, patterns, features, keywords, or labels, which are used as reference data for comparison and model training.

The term “scoring of an abnormality” refers to a process of assigning a numerical or categorical score that represents a degree of deviation from normal or expected behavior or content, such as a degree of suspicion that the text data indicates fraud.

The term “analysis result” refers to data produced by the processor after performing text analysis and fraud assessment, including but not limited to detected keywords or phrases, similarity measures to past fraud cases, anomaly scores, and overall fraud risk scores or levels.

The term “appropriate response” refers to a text or speech content generated based on the analysis result that is designed to safely probe the caller's or counterpart's intent, verify authenticity, or reduce fraud risk, without revealing sensitive information or encouraging fraudulent actions.

The term “probing a possibility of fraud” refers to the act of using one or more responses, questions, or verification steps to further clarify whether an interaction is fraudulent or legitimate, for example by requesting additional information, official verification, or documentation.

The term “proposed response” refers to an appropriate response generated by the processor and presented to the user as a suggestion, which the user may review, accept, modify, or reject before using in a communication.

The term “agent response” refers to an automatic response in which the processor uses the generated appropriate response to reply to the counterpart on behalf of the user, for example by synthesizing and outputting speech during a call without the user manually speaking all of the content.

The term “speech synthesis technique” refers to any algorithm, model, or software that converts text data into audio data representing artificial speech, including but not limited to text-to-speech (TTS) systems based on concatenative synthesis, parametric synthesis, or neural network-based synthesis.

The term “natural speech” refers to synthesized audio output that is generated by a speech synthesis technique and is intended to resemble human speech in terms of pronunciation, prosody, intonation, and timing, such that it does not give an unnatural impression to a counterpart.

The term “counterpart” refers to a party other than the user participating in the communication, such as a caller, callee, or any person or system on the opposite side of the telephone call or voice interaction.

The term “real-time response” refers to a response operation performed by the processor and the system within a time frame that is sufficiently short to allow the user or the counterpart to perceive the response as occurring without significant delay during an ongoing conversation. The term “response content” refers to the specific textual or semantic content of a generated response, including questions, statements, confirmations, refusals, or warnings that are output to or on behalf of the user.

The term “continuous evaluation of safety” refers to an ongoing process in which the processor repeatedly or periodically updates a measure of fraud risk or communication safety during the progression of an interaction, based on newly obtained text data, features, or analysis results.

The term “score” refers to a numerical, symbolic, or categorical value that represents a degree of fraud risk, abnormality, or safety, and that may be updated as additional information is processed.

The term “newly detected information” refers to additional data or features obtained after an initial analysis, including later segments of text data, new keywords or patterns, or any subsequent analysis results that arise as the interaction continues.

The term “adjusting response content” refers to modifying, regenerating, or selecting alternative responses based on updated analysis results or scores, in order to better reflect the current assessed level of fraud risk or safety.

The term “notify a user” refers to providing information to the user by visual, auditory, or other output means, including but not limited to on-screen messages, alerts, icons, sounds, or synthesized speech, indicating a fraud risk level, a safety condition, or recommended actions. The term “details of the interaction” refers to information summarizing or characterizing the communication between the user and the counterpart, including key messages, detected risk indicators, timestamps, and analysis results that help the user understand why a certain fraud or safety determination was made.

The term “warning” refers to a notification or message provided to the user that indicates an elevated or high possibility of fraud, and that advises the user to take protective actions such as refraining from sharing sensitive information or terminating the communication.

The term “blocking the interaction” refers to automatically or semi-automatically restricting, suspending, or terminating the communication between the user and the counterpart, such as ending a call, preventing further responses, or limiting certain operations, in order to protect the user when a high possibility of fraud is determined.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

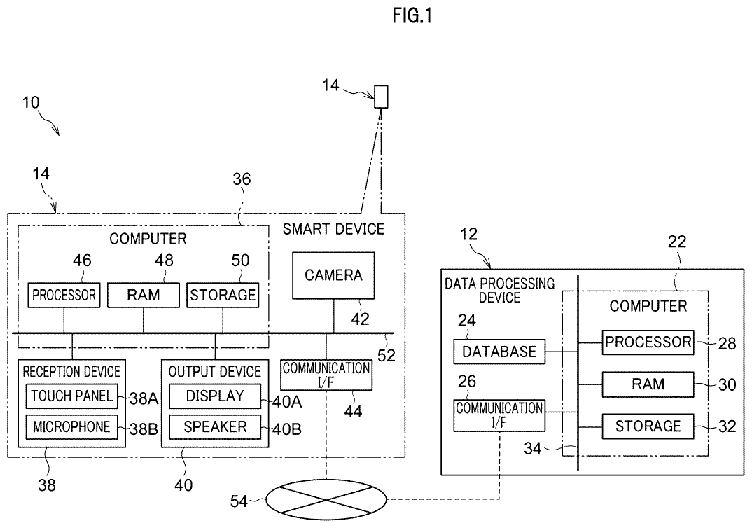

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

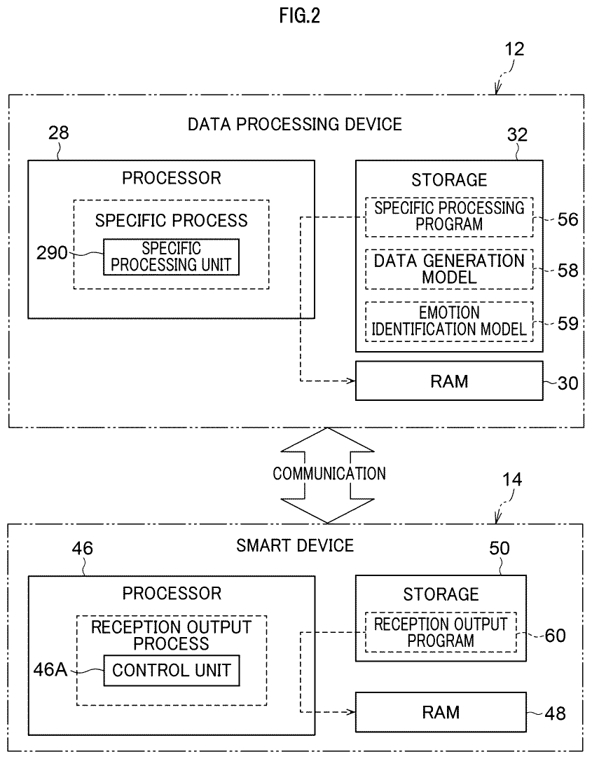

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional fraud-detection techniques for voice communications typically rely on post-hoc analysis of stored call recordings or on simple keyword matching performed on limited text transcripts. Such approaches suffer from several technical drawbacks. First, they do not provide sufficiently low-latency processing to intervene during an ongoing call, because audio must be fully recorded, uploaded, and batch-processed on a remote system. Second, they are usually based on rigid rules or fixed keyword lists, which cannot robustly capture evolving fraud patterns and often generate false positives or false negatives. Third, conventional systems are not architected to maintain and update a structured risk representation as the conversation unfolds turn by turn; instead, they treat each utterance or message in isolation, which degrades risk-estimation accuracy and temporal consistency. Furthermore, existing architectures generally separate automatic speech recognition, fraud scoring, and response suggestion into loosely coupled components without a unified control flow. There is typically no mechanism to feed back updated risk assessments into the generation of follow-up questions or defensive responses in real time. As a result, the computing resources of both the user terminal and the server are not effectively utilized to coordinate incremental speech recognition, context-aware natural language processing, similarity search over historical fraud cases, and adaptive response generation. This leads to increased network traffic, redundant processing, and delayed or suboptimal interventions. In addition, while recent generative AI models are capable of generating natural language responses, conventional systems lack a concrete mechanism for constructing structured prompt sentences that integrate real-time fraud risk indices, similarity-search results over past fraud cases, and conversation context in a way that is suitable for secure, safety-critical decision making. Without such prompt construction and control, generative AI models may produce responses that inadvertently disclose personal information, fail to perform adequate identity verification, or do not adjust their defensive level according to the dynamically changing risk.

Moreover, existing voice-assistant or call-assistant solutions typically output canned messages via text or simple synthesized speech without tightly coupling the prosody, speaking rate, and content defensiveness to a continuously updated, model-based fraud risk index. This limits the ability of the computing system to provide real-time, context-appropriate, and technically robust protection during a live call, and does not effectively exploit the capabilities of modern machine-learning-based text analysis and speech synthesis.

Accordingly, there is a need for an improved computer-implemented system and method that: (i) efficiently acquires and converts audio from a user terminal into structured text segments including timestamps and speaker information; (ii) executes, on a server, a coordinated pipeline of natural language processing, machine-learning-based fraud risk scoring, and similarity search over stored fraud cases; (iii) constructs and updates prompt sentences for a generative AI model based on conversation history and dynamic fraud risk indices; (iv) generates, in real time, adaptive response text for fraud probing and identity verification; and (v) controls speech synthesis and call handling at the user terminal in accordance with the updated fraud risk index. Such a system should improve the functioning of the underlying computer technology by reducing processing latency, optimizing server-side model utilization, enabling stateful risk management across conversation turns, and providing a technically grounded integration of generative AI into a safety-critical communication workflow.

The specific processing by the specific processing unit 290 of the data processing device 12 in Example 1 is realized by the following means.

The present invention provides a server comprising a processor and a memory storing instructions which, when executed by the processor, cause the processor to receive, via a communication interface, text information generated at a user terminal from audio information acquired during a voice communication, the text information including character string information, time information, and speaker classification information; to perform natural language processing on the text information to execute preprocessing, segmentation into lexical or subword units, extraction of structural and pragmatic information, and generation of feature information including expressions related to fraudulent activity; to generate, based on the feature information, a fraud risk index by using a machine-learning model, generate an embedding vector corresponding to the text information, execute similarity search against stored fraud case information using the embedding vector, and update the fraud risk index based on a search result; to construct, based on the text information, the fraud risk index, the feature information, and conversation history, a prompt sentence to be input to a generative AI model, input the prompt sentence to the generative AI model, and generate response text for confirmation of a counterpart's intention or additional fraud-risk evaluation based on output text obtained from the generative AI model; to transmit the response text and the fraud risk index to the user terminal such that the response text is usable at the user terminal as presentation to a user or as a proxy response in the communication; to sequentially update the fraud risk index in response to additional reception of text information corresponding to subsequent utterances, and to dynamically change content or manner of the prompt sentence and the response text according to the updated fraud risk index; and to, when the fraud risk index exceeds a predetermined threshold, transmit warning information to the user terminal to enable control of continuation or interruption of the communication, and when the fraud risk index satisfies a predetermined low-risk condition, transmit summary information of the communication and final safety-evaluation information to the user terminal. This enables an integrated, computer-implemented fraud-mitigation workflow in which server-side natural language processing, machine-learning-based risk scoring, similarity search, and generative AI response generation are orchestrated in real time with terminal-side speech recognition and speech synthesis, thereby improving system-level latency, accuracy, and adaptability of fraud detection and response during ongoing voice communications.

The term “user terminal” refers to an information processing apparatus operated by a user, such as a communication device or computing device, that acquires audio information during a voice communication, executes speech recognition and speech synthesis processing, performs user interaction, and communicates text information and control information with a server.

The term “audio information” refers to time-varying data representing sound, including at least voice signals captured during a communication, which may be represented as analog waveforms or digitized samples suitable for processing by a computing device.

The term “speech recognition processing” refers to a computational procedure that converts audio information representing speech into character string information by analyzing acoustic features and applying one or more acoustic models and language models.

The term “character string information” refers to data representing recognized linguistic content of speech as a sequence of characters, symbols, or tokens suitable for natural language processing.

The term “text information” refers to structured data including at least character string information and associated metadata such as time information and speaker classification information, which is generated from audio information and is used as input to subsequent analysis and processing.

The term “time information” refers to data indicating a temporal attribute of text information, including at least a time stamp or time interval corresponding to when the associated audio information was acquired or when a corresponding utterance occurred.

The term “speaker classification information” refers to data indicating a classification of a speaker associated with a segment of text information, such as identification of whether the speaker is a user, a counterpart party, or another role in a communication.

The term “communication path” refers to a logical or physical connection, including at least a wired or wireless network, through which data such as text information, response text, and control information is transmitted between a user terminal and a server.

The term “natural language processing” refers to computational techniques for analyzing, understanding, and transforming human language text, including preprocessing, tokenization, syntactic analysis, semantic analysis, and pragmatic analysis.

The term “preprocessing” refers to operations performed on text information before higher-level analysis, including at least normalization, tokenization, segmentation into units such as words or subwords, filtering, or masking of specified elements.

The term “lexical unit” refers to a unit of text corresponding to a word or term that is treated as a basic element in natural language processing.

The term “subword unit” refers to a segment of a word, such as a morpheme, character sequence, or model-specific token, used as a basic element for machine-learning-based language processing.

The term “structural information” refers to information indicating syntactic or grammatical structure of text, including at least part-of-speech tags, phrase structure, or dependency relations between tokens.

The term “pragmatic information” refers to information indicating communicative intent, discourse function, or contextual use of expressions within text, including at least indications of urgency, pressure, politeness, or requests for action.

The term “feature information” refers to data derived from text information and natural language processing that characterizes content, structure, or context, and includes at least information indicating expressions related to fraudulent activity and other attributes used as input to a machine-learning model.

The term “expression related to fraudulent activity” refers to an expression, phrase, or textual pattern indicative of potential fraud, such as requests for immediate payment, disclosure of sensitive information, or transfer of assets under urgent or suspicious circumstances.

The term “machine-learning model” refers to a computational model obtained by training on data so as to learn parameters or structures that map input data to output values, and includes at least classification models, regression models, or neural network models used to compute a fraud risk index.

The term “fraud risk index” refers to a quantitative or qualitative value indicating an estimated level of risk that a communication involves fraudulent activity, computed using feature information and a machine-learning model, and updatable as additional text information is received.

The term “embedding vector” refers to a numerical vector representation of text information or part thereof in a continuous vector space, generated by a model such as an embedding model or language model, and used for similarity computation or retrieval.

The term “similarity search” refers to a computational process of retrieving one or more stored items, such as fraud case information, whose embedding vectors or other representations are similar to a query embedding vector, according to a similarity measure such as cosine similarity or distance.

The term “fraud case information” refers to stored information about past communications or events that have been classified or labeled as fraudulent or non-fraudulent, including at least text data, derived feature information, and associated labels or metadata.

The term “storage means” refers to one or more storage resources, such as memory devices or databases, configured to store fraud case information, configuration information, or other data used by the system.

The term “search result” refers to information obtained from similarity search, including at least identifiers of retrieved fraud case information and similarity scores or rankings associated therewith.

The term “generative information processing model” refers to a generative AI model that receives a prompt sentence or related input and generates output text, such as a large-scale language model implemented by machine-learning techniques.

The term “generative AI model” refers to a generative information processing model specifically implemented using artificial intelligence techniques, such as deep neural networks, that produces natural language text in response to input prompts.

The term “prompt sentence” refers to a structured text input that is provided to a generative information processing model and that may include instructions, context information, risk information, and other content guiding the model's generation behavior.

The term “output text” refers to text generated by a generative information processing model in response to a prompt sentence, and used as a basis for constructing response text. The term “response text” refers to text generated by the system, based at least on output text from a generative information processing model, for use in confirming a counterpart party's intention, performing additional fraud-risk evaluation, or communicating with the counterpart party.

The term “conversation history” refers to accumulated information about utterances or messages exchanged in a communication session, including their text information, time information, speaker classification information, and associated analysis results.

The term “sequentially update” refers to updating a value, such as a fraud risk index, in response to newly received text information or other input, such that the updated value reflects changes over time during an ongoing communication.

The term “content or manner of the prompt sentence” refers to at least the textual content, tone, length, structure, included context elements, and instructions of a prompt sentence provided to a generative information processing model.

The term “content or manner of the response text” refers to at least the textual content, tone, length, structure, level of defensiveness, and type of questions or statements included in response text generated by the system.

The term “predetermined threshold” refers to a reference value or condition set in advance, or adaptively configured, used to determine whether a fraud risk index indicates a high-risk state requiring enhanced measures.

The term “low-risk condition” refers to a condition, defined by one or more criteria such as a fraud risk index value below a threshold or a stable low-risk trend, under which a communication is deemed to have low fraud risk.

The term “warning information” refers to information transmitted to a user terminal indicating that a fraud risk index exceeds a predetermined threshold and recommending or enabling actions such as interruption or modification of a communication.

The term “summary information of the communication” refers to information representing an overview of a communication session, including at least main topics, key risk-related events, and relevant system determinations, which is generated for presentation to a user.

The term “final safety evaluation information” refers to information indicating an overall evaluation of the safety or fraud risk of a completed communication, determined based on the fraud risk index and associated analysis results.

The term “proxy response” refers to a response output to a counterpart party by the system on behalf of a user, such that the content is generated or controlled by the system rather than directly by the user's manual speech.

The term “speech synthesis processing” refers to a computational procedure that converts response text into audio information representing synthetic speech, by generating acoustic features and waveforms from textual input.

The term “communication audio output” refers to audio information output to a communication channel, such as a voice call path, for perception by a counterpart party as part of a conversation.

The term “voice characteristic of the user” refers to one or more properties of a user's speech, such as pitch, timbre, speaking rate, or accent, which may be used to configure or select a voice profile for speech synthesis.

The term “voice profile” refers to configuration data defining properties of synthetic speech, including at least voice quality, pitch, speaking rate, and language, used by a speech synthesis process.

The term “prosody” refers to suprasegmental features of speech, including pitch, intonation, stress, and rhythm, which are controlled to influence naturalness or communicative effect of synthesized speech.

The term “defensive level of response content” refers to a degree to which response text is configured to avoid divulging information, to demand verification, or to limit cooperation, in accordance with an estimated fraud risk.

The term “follow-up question” refers to a question included in response text, generated to obtain additional information from a counterpart party for purposes such as identity verification or fraud-risk assessment.

The term “legitimacy confirmation item” refers to an item of information requested from a counterpart party, such as an official reference number or verifiable contact information, that enables confirmation of the legitimacy of a request or communication.

The term “personal information non-disclosure policy” refers to a constraint applied to response text generation, specifying that certain categories of personal or sensitive information shall not be requested, transmitted, or disclosed by the system.

The term “response generation policy” refers to one or more rules, constraints, or objectives provided to a generative information processing model, defining desired properties of generated response text, such as safety level, politeness, length, or verification focus.

In one embodiment, a server cooperates with a terminal operated by a user to implement a fraud-mitigation system for voice communications. The terminal includes a microphone, a speaker, a display, a communication interface, and a processor. The server includes at least one processor, a memory, a network interface, and non-volatile storage. The server and the terminal are connected via a wired or wireless communication network. The terminal executes an application program that acquires audio information during a voice call or voice message playback, converts the audio information into text information including character string information, time information, and speaker classification information, and exchanges the text information and control information with the server. The server executes a program that performs natural language processing, fraud risk scoring based on a machine-learning model, similarity search over stored fraud case information, prompt sentence construction for a generative AI model, response text generation, and control of warning notifications and communication behavior at the terminal.

The terminal uses hardware resources of a user device, such as a smartphone processor (for example, a multi-core application processor), a tablet processor, or a personal computer processor. The terminal performs speech recognition processing by using a speech recognition engine implemented in software, such as a platform-provided speech recognition library or an embedded automatic speech recognition library. In one example, the terminal uses a speech recognition framework comparable to a mobile operating system speech API or a local engine similar to an open-source speech recognizer. The terminal captures audio samples from the microphone as digitized audio frames, for example 16-bit PCM samples at a sampling rate such as 16 kHz or 44.1 kHz, and passes these samples to the speech recognition engine, which computes acoustic feature vectors, such as mel-frequency cepstral coefficients. The terminal then obtains character string information as recognition results.

The terminal generates text information by associating the character string information with time information indicating the acquisition time or time interval of each utterance and with speaker classification information indicating whether the utterance is attributed to the user or to a counterpart party. The terminal stores the text information in a data structure, such as a list or array of segment objects, each object containing fields for text, timestamp, and speaker role. The terminal transmits the text information to the server over an encrypted communication channel, such as a network connection using a secure transport protocol. The server stores one or more trained machine-learning models and a set of fraud case information in a database or other storage resource. The server uses a general-purpose operating system and a runtime environment to execute a server application that implements the natural language processing and fraud analysis pipeline. In one example embodiment, the server uses a transformer-based neural network model as a text encoder and classifier. The server loads model parameters stored in the memory, where the neural network comprises multiple layers of self-attention, feedforward sublayers, and normalization layers. Each layer uses learned weight matrices and bias vectors, which the server applies to token embeddings and positional encodings of the input text.

The server, upon receiving the text information from the terminal, performs normalization and tokenization on the character string information. The server converts text into subword units using a predefined vocabulary, assigns integer token identifiers, and embeds these tokens into continuous vectors. The server then feeds the sequence of token embeddings into the neural network model to obtain contextual representations of tokens and sentences. The server aggregates these contextual representations, for example by pooling or using a special classification token, to produce feature information representing a sentence-level or segment-level embedding.

The server generates feature information including structural information, such as syntactic dependencies, as well as pragmatic information, such as indications of urgency or pressure, by combining outputs from linguistic analysis modules and outputs from the neural network encoder. The server applies a classifier layer on top of the encoder output to compute a fraud risk index. The classifier layer may consist of one or more fully connected layers, followed by an activation function such as a softmax or sigmoid function. The server interprets the classifier output as a probability or score representing the likelihood that the corresponding segment or communication is fraudulent.

The server also generates an embedding vector corresponding to the text information by using an encoder part of the neural network. The server stores such embedding vectors in a high-dimensional vector space and uses a similarity search algorithm, such as approximate nearest neighbor search, to retrieve similar vectors from storage means that hold previously stored fraud case information. The server calculates similarity scores, such as cosine similarity, between the current embedding and stored embeddings, and retrieves identifiers and summary information of similar fraud cases.

The server updates the fraud risk index based on similarity scores, features of matched fraud cases, and the output of the classifier. For example, the server applies a learned or rule-based aggregation function that increases the fraud risk index if a high similarity is detected to known fraud patterns, or that adjusts the index based on multiple similar cases. This combination of classifier output and similarity search result reduces false negatives and improves robustness to new but related fraud patterns.

The server constructs a prompt sentence for a generative AI model by integrating the current conversation context, the fraud risk index, and the similarity search results. The server arranges the prompt sentence in a textual format that instructs the generative AI model to produce safe and investigative responses. The server includes in the prompt sentence a role description, key utterances from the conversation history, the fraud risk index value, and summary information of relevant past fraud cases. The server also includes a response generation policy specifying that no personal information should be disclosed and that identity verification and legitimacy checks must be emphasized.

The server generates, for example, a prompt sentence such as:

“You are a security assistant using a fraud risk score system.

The current risk score is 0.87 (high).

The caller says: ‘This is an urgent notice. You must transfer 3000 dollars today to avoid legal action. Please give me your bank account details now.’

Generate a short, polite response that does not share any personal data but asks for official verification and additional information to check if this is a scam.”

The server may also use prompt sentences such as:

“The following caller message may be a fraud attempt: ‘We detected suspicious activity on your account. Please tell me your full credit card number and the 3-digit code on the back so we can secure your account immediately.’

What questions should the user ask to safely verify the caller's identity and the legitimacy of this request? Provide several short, polite questions.”

Or:

“Given this message: ‘Your bank account will be frozen in 2 hours unless you transfer your balance to a safe account we provide,’
generate a short response that does not share any personal data but politely asks the caller for official verification, such as case numbers or callback numbers from the official website.” The server transmits the constructed prompt sentence to a generative AI model. In one embodiment, the server uses a transformer-based generative language model that has been pre-trained on large-scale text data and optionally fine-tuned on safety-critical dialogues. The server sends the tokenized prompt to the generative model, which computes multiple layers of self-attention and feedforward transforms to predict output token probabilities. The server obtains output text by sampling or decoding according to a chosen strategy, such as beam search or nucleus sampling, subject to constraints on maximum length and safety filters. The server applies post-processing rules to the output text to ensure compliance with the response generation policy. For example, the server checks whether the output text requests or reveals sensitive attributes, and, if such content is detected, modifies or regenerates the response using a more restrictive prompt sentence. The server finally generates response text that includes follow-up questions, legitimacy confirmation items, and instructions avoiding disclosure of personal data.

The server sequentially updates the fraud risk index as new text information arrives from the terminal. The server maintains a session state that includes accumulated text segments, corresponding feature information, and previous fraud risk indices. The server recalculates the fraud risk index by incorporating new segments into the neural network input, updating embeddings, re-running the classifier, and updating similarity searches. The server thus provides a dynamic risk assessment that reflects the entire conversation history, rather than isolated utterances.

The server also adapts the content or manner of prompt sentences and response text based on the updated fraud risk index. When the fraud risk index increases, the server tightens the response generation policy so that the generative AI model produces more defensive responses, such as firm refusals to provide information and demands for independent verification. When the fraud risk index decreases and remains below a low-risk condition, the server relaxes the responses while still avoiding unnecessary disclosure of sensitive information. This adaptive control of generative output based on computed risk indices improves the technical behavior of the system by aligning the generative model with real-time risk estimates and by reducing inappropriate or unsafe responses.

The server transmits the response text and the fraud risk index to the terminal. The terminal displays the response text to the user as suggested content and may highlight the fraud risk index with a color or icon to indicate the risk level. The user may select to accept, modify, or reject the suggested response. If the user accepts the response, the terminal converts the response text into audio information by using a speech synthesis engine. The terminal controls prosody and speaking rate based on a voice profile associated with the user or configured by the user. The terminal outputs the synthesized audio through the communication audio path so that the counterpart party perceives the response as part of the voice communication.

The terminal, by using built-in audio hardware and software interfaces, injects the synthesized audio into the ongoing call. This direct control of call audio distinguishes the system from mere text suggestion tools and provides a technical coupling between generative text processing and physical audio output hardware. The terminal may also adjust volume and equalization parameters to improve intelligibility and to maintain naturalness of the synthesized speech.

The server, upon detecting that the fraud risk index has exceeded a predetermined threshold, generates warning information and transmits it to the terminal. The terminal presents a visual alert or an audible alert to the user, and may provide interface elements to immediately terminate the call or to switch to a safer interaction mode. In one embodiment, the terminal automatically terminates the call when the fraud risk index is extremely high, according to user preferences. This coordinated control of communication based on computed indices involves concrete control of device behavior and network usage, and results in reduced exposure time to fraudulent communications.

The server, when the fraud risk index satisfies a low-risk condition at the end of a communication, generates summary information of the communication and final safety evaluation information and sends them to the terminal. The terminal displays a concise summary of suspicious or relevant elements and indicates the final safety evaluation. The user can review the summary for confirmation and may label the communication as fraudulent or safe, improving the training data for future model updates.

The server improves computer technology in several ways. The server reduces processing latency by performing incremental, segment-based analysis and by updating embeddings and risk indices in a streaming manner, instead of applying batch processing after the call ends. The server increases accuracy by combining classifier outputs with similarity search results over a structured embedding space of past fraud cases, leveraging high-dimensional vector representations that are not available in traditional rule-based systems. The server also improves communication efficiency by transmitting compact text information and embedding vectors instead of large raw audio data, thereby reducing network bandwidth usage. The server uses a training process for the neural network models that includes supervised learning on labeled fraud and non-fraud texts. The server minimizes a loss function, such as cross-entropy loss, that compares predicted fraud labels to ground truth labels. The server updates model weights by using gradient-based optimization algorithms, such as stochastic gradient descent or adaptive methods, applied over mini-batches of training data. The server employs data augmentation techniques, such as paraphrase generation, noise injection, or sampling from similar fraud cases, to increase robustness. The server stores learned weight parameters in persistent memory so that they can be used at inference time.

The server, by constructing prompt sentences in a non-conventional manner that embeds machine-computed risk indices, similarity-based evidence, and explicit safety policies, employs processing steps that differ from typical human procedures. A human operator typically cannot compute high-dimensional similarity against large repositories of fraud cases in near real time during a live call. The server, by contrast, processes large numbers of embedding vectors and applies approximate nearest neighbor search algorithms optimized for modern hardware, such as vectorized instructions and parallel processing cores. This processing architecture enables risk-aware generative behavior at a speed and scale that are not achievable by manual methods.

The terminal also benefits from optimization. The terminal performs local speech recognition and speech synthesis, which reduces the amount of audio that must be transmitted to the server and lowers end-to-end latency. The terminal can use hardware acceleration, such as a neural network accelerator or a digital signal processor, to compute acoustic features and synthesize speech. This architecture reduces the computational load on the server and improves scalability across many users.

Several variations of the embodiment are possible. In one variation, the terminal performs only partial speech recognition and sends audio features to the server, where a server-side speech recognition model completes transcription, allowing more advanced language models to run on more powerful hardware. In another variation, the server uses multiple machine-learning models, such as a first model specialized in detecting financial fraud patterns and a second model specialized in detecting impersonation fraud, and aggregates their outputs into a composite fraud risk index. In another variation, the generative AI model is deployed on-premise within the server infrastructure, while in a different variation, the generative AI model is accessed through an external service, with the server enforcing strict prompt construction and response filtering.

The system described above is not limited to telephone calls but can be applied to any real-time voice communication, such as voice over network communications or conferencing systems. In each case, the terminal and the server cooperate to acquire, process, and respond to audio information using specific data structures, neural network architectures, and device control mechanisms, thereby providing technical improvements in risk-aware voice communication processing.

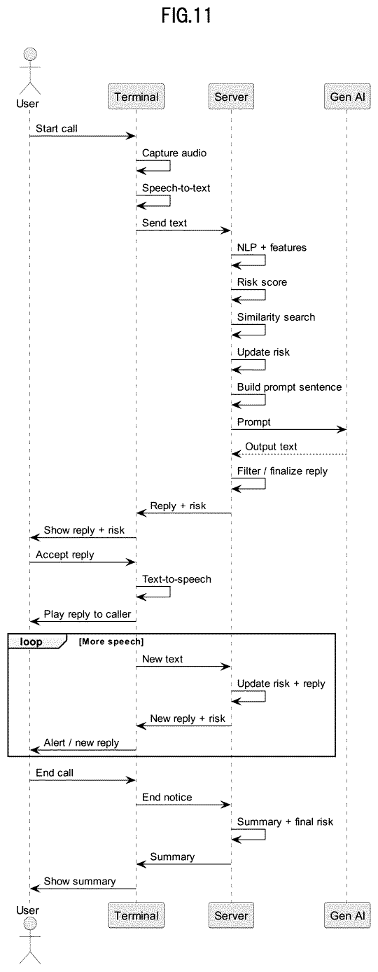

The following describes the processing flow using FIG. 11.

### Step 1:

The user initiates or receives a voice communication on the terminal.

The terminal receives, as input, analog voice signals from a microphone during a call or voice session.

The terminal converts the analog signals into digital audio samples (for example, 16-bit PCM at 16 kHz) using an audio codec and stores the samples in an audio buffer in memory. The terminal outputs buffered digital audio frames as a continuous stream that is available both to the communication stack and to a local speech recognition engine.

### Step 2:

The terminal performs speech recognition on the captured audio.

The terminal receives, as input, the digital audio frames from the audio buffer. The terminal segments the audio stream into time windows (for example, 1-2 seconds each), computes acoustic feature vectors such as mel-frequency cepstral coefficients on each window using the terminal processor or a signal-processing accelerator, and feeds the feature vectors into a local automatic speech recognition model.

The terminal decodes the feature vectors into token sequences (characters, words, or subwords) using an acoustic model and a language model stored in local memory.

The terminal outputs recognized character string information for each audio window, together with confidence scores.

### Step 3:

The terminal constructs structured text information including timestamps and speaker roles. The terminal receives, as input, recognized character string information and associated timing metadata from the speech recognition engine, as well as call-control information indicating which direction of audio (user or counterpart) is being processed.

The terminal associates each character string with time information (start and end times) and assigns speaker classification information (for example, “user” or “counterpart”) based on call-direction metadata.

The terminal packs these elements into a data structure for each utterance, such as a segment object containing fields for text, timestamp, speaker, and recognition confidence. The terminal outputs a sequence of text segments forming text information for the ongoing communication.

### Step 4:

The terminal transmits the text information to the server.

The terminal receives, as input, the sequence of text segments generated in Step 3.

The terminal aggregates multiple segments into a batch, serializes the batch into a request message (for example, in JSON format), and opens a secure connection to the server via a communication interface.

The terminal sends the serialized text information, including segment text, time information, and speaker classification information, to a predetermined endpoint on the server. The terminal outputs a network request containing the text information as the payload.

### Step 5:

The server accepts and stores the incoming text information.

The server receives, as input, the network request from the terminal containing the batched text segments.

The server authenticates the request, parses the serialized payload into internal data structures, and associates the segments with a session identifier stored in session memory.

The server appends the received segments to a conversation history structure in memory or in a database, preserving the order given by the timestamps.

The server outputs an updated conversation history object that includes all text information received so far for the session.

### Step 6:

The server performs text preprocessing and tokenization.

The server receives, as input, the updated conversation history object from Step 5. The server normalizes the text (for example, lowercasing, handling punctuation, and masking certain numeric patterns), and splits the text of each segment into sentences if necessary. The server applies a tokenizer associated with a transformer-based encoder to convert each sentence into a sequence of token identifiers, adding special tokens such as sentence start and end markers.

The server outputs, for each segment, a token sequence and corresponding mapping back to the original text span.

### Step 7:

The server extracts linguistic features and contextual embeddings.

The server receives, as input, the token sequences from Step 6.

The server embeds each token identifier into a dense vector using a learned embedding matrix and combines the token embeddings with positional encodings.

The server feeds the embedded token sequences through multiple layers of a transformer encoder, each layer applying self-attention and feedforward transformations to propagate contextual information across tokens.

The server aggregates the encoded token representations, for example using a special classification token or pooling, to obtain segment-level embeddings.

The server optionally runs a linguistic analysis tool to obtain structural information such as part-of-speech tags and dependency relations, and pragmatic information such as sentence mood or indicators of urgency.

The server outputs feature information for each segment, including at least an embedding vector and extracted linguistic attributes.

### Step 8:

The server computes a fraud risk index using a machine-learning classifier.

The server receives, as input, the feature information from Step 7.

The server passes the segment-level embeddings and selected linguistic attributes into a classifier network consisting of one or more fully connected layers followed by a non-linear activation and a final output layer that produces a score for fraud likelihood.

The server calculates a fraud probability or score for each segment and combines segment-level scores across the conversation history using an aggregation function (for example, weighted average with more weight on recent segments or maximum of recent scores).

The server outputs an updated fraud risk index for the session and intermediate scores for individual segments.

### Step 9:

The server performs similarity search over stored fraud case information.

The server receives, as input, the segment-level embeddings from Step 7 and the session-level embedding derived from aggregation.

The server queries a vector index that stores embedding vectors for historical fraud and non-fraud cases, using approximate nearest neighbor algorithms to retrieve items whose embeddings are close to the current session embedding.

The server computes similarity measures, such as cosine similarity, between the current embedding and candidate case embeddings, and selects top-ranked similar fraud cases. The server extracts associated metadata and summaries from the retrieved cases.

The server outputs similarity search results, including identifiers of similar cases, similarity scores, and brief descriptions.

### Step 10:

The server updates the fraud risk index using similarity search results.

The server receives, as input, the fraud risk index from Step 8 and the similarity search results from Step 9.

The server applies a risk-adjustment function that increases or decreases the fraud risk index based on similarity scores and labels of retrieved cases, for example raising the index when several high-similarity fraudulent cases are found.

The server generates an adjusted fraud risk index that reflects both classifier output and similarity evidence.

The server outputs the adjusted fraud risk index and keeps it as the current risk indicator for the session.

### Step 11:

The server constructs a prompt sentence for a generative AI model.

The server receives, as input, the conversation history, the feature information, the adjusted fraud risk index, and the similarity search results.

The server selects recent segments and key utterances, extracts summaries of relevant past fraud cases, and determines a response generation policy based on the risk level (for example, more defensive when risk is high).

The server concatenates these elements into a structured natural language prompt sentence that instructs the generative AI model to generate an appropriate response, explicitly stating the current risk score and the requirement not to disclose personal information. The server outputs a prompt sentence such as:

“You are a security assistant using a fraud risk score system. The current risk score is 0.87 (high). The caller says: ‘This is an urgent notice. You must transfer 3000 dollars today to avoid legal action. Please give me your bank account details now.’ Generate a short, polite response that does not share any personal data but asks for official verification and additional information to check if this is a scam.”

### Step 12:

The server invokes the generative AI model to obtain candidate response text.

The server receives, as input, the prompt sentence from Step 11.

The server tokenizes the prompt according to the vocabulary of the generative AI model and sends the token sequence to the model running either locally on the server hardware or on a connected inference service.

The generative AI model processes the tokens through multiple decoder layers with self-attention and cross-attention mechanisms to predict output tokens one by one.

The server decodes the predicted token sequence back into text, using a decoding strategy such as beam search with constraints on maximum length and temperature.

The server outputs candidate output text generated by the generative AI model.

### Step 13:

The server post-processes the candidate output text to generate final response text. The server receives, as input, the candidate output text from Step 12 and the response generation policy determined in Step 11.

The server analyzes the candidate text to detect disallowed content, such as direct requests to send passwords or to share sensitive identifiers, and removes or replaces such content according to predefined rules.

The server may regenerate part or all of the response by issuing a modified prompt sentence when the candidate text violates safety constraints.

The server outputs final response text that conforms to the policy, including follow-up questions and legitimacy confirmation items while refraining from revealing personal information.

### Step 14:

The server sends the response text and fraud risk index to the terminal.

The server receives, as input, the final response text from Step 13 and the adjusted fraud risk index from Step 10.

The server packages these values into a response message, optionally including additional metadata such as a risk level category and recommended user actions, and sends the message to the terminal via the network interface.

The server outputs a network response containing the response text and the fraud risk index. Step 15:

The terminal presents the response text and risk information to the user.

The terminal receives, as input, the network response from the server that includes the response text and fraud risk index.

The terminal updates the user interface to display the suggested response as text and to show the risk level, for example using color coding or icons indicating “low,” “medium,” or “high” risk

The terminal accepts user input, such as tapping a button to accept, edit, or reject the suggested response.

The terminal outputs a user selection indicating how the response text should be used.

### Step 16:

The terminal synthesizes speech for accepted response text.

The terminal receives, as input, the final response text selected by the user in Step 15.

The terminal passes the text to a text-to-speech engine, which converts the text into a phoneme or acoustic feature sequence, and then generates a waveform using a vocoder model or platform speech synthesis library.

The terminal controls prosody and speaking rate according to a preconfigured voice profile and may adjust volume or emphasis based on the fraud risk index (for example, slower and more deliberate speech for high-risk situations).

The terminal outputs synthesized audio samples representing the response speech.

### Step 17:

The terminal injects synthesized audio into the ongoing communication.

The terminal receives, as input, the synthesized audio samples from Step 16.

The terminal forwards the samples to the communication audio path using operating system audio APIs so that they are transmitted over the voice channel to the counterpart party. The terminal may synchronize the injection with call-control events to avoid overlapping with the user's own speech.

The terminal outputs communication audio that the counterpart party perceives as the user's spoken response.

### Step 18:

The server continuously updates the fraud risk index as the conversation progresses.

The server receives, as input, additional batches of text information from the terminal as the call continues.

The server repeats Steps 6 through 10 for new segments, recomputing embeddings, classifier outputs, similarity search results, and aggregated risk values.

The server compares the updated fraud risk index against predetermined thresholds and detects transitions between risk levels.

The server outputs new risk indices and, when thresholds are crossed, triggers additional prompt construction, response generation, or warning messages.

### Step 19:

The terminal reacts to warning information and controls call handling.

The terminal receives, as input, warning information and updated fraud risk indices from the server.

The terminal displays explicit alerts to the user, such as a message recommending termination of the call, and may optionally vibrate or emit a sound to attract attention.

The terminal offers actions such as “End call now” or “Continue with caution,” and may, according to user settings, automatically end the call when the risk index exceeds a critical level.

The terminal outputs call-control commands to the communication subsystem, thereby continuing or terminating the call based on detected fraud risk.

### Step 20:

The server generates and delivers a post-conversation summary and final safety evaluation. The server receives, as input, a notification from the terminal that the communication has ended, together with the final conversation history and final fraud risk index.

The server optionally uses a generative AI model with a summary-oriented prompt sentence to produce concise summary information of the communication focusing on risk-related elements, and combines this with the final safety evaluation.

The server sends the summary information and safety evaluation information to the terminal for user review.

The server outputs stored logs and summary data that can be used for later analysis, model retraining, and improvement of fraud detection performance.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computerized security and fraud-detection systems that process audio interactions suffer from several technical limitations. First, existing systems typically implement fixed rule-based keyword matching or static classification pipelines that do not adapt their behavior as a conversation progresses. As a result, the systems fail to update their internal risk assessment in real time and cannot tailor subsequent processing steps or system outputs to newly observed evidence. This leads to inaccurate threat assessments, either missing genuine threats or generating excessive false positives, which degrades the reliability of the overall computing system.

Second, in many systems that employ machine learning or generative models, the construction of prompts or inputs to such models is manually defined, static, and decoupled from low-level system state such as continuously changing risk scores, anomaly metrics, or historical similarity measures. The computing pipeline therefore cannot systematically incorporate multi-source analysis results and dynamic safety indices into the generative model input. This fixed prompt design constrains the quality and consistency of generated responses and prevents the system from exploiting real-time computational context, resulting in inefficient use of processing resources and suboptimal output quality.

Third, conventional architectures typically separate audio processing, natural language understanding, and response generation into loosely coupled components without a unified feedback mechanism. The systems do not store and reuse past analysis results, generated responses, and incident outcomes in a structured manner that can improve future computation. Without feedback-driven refinement of both threat evaluation logic and prompt generation logic, the computational pipeline stagnates, and the underlying models cannot be tuned to the specific operational environment or evolving attack patterns. This causes the system to use generic models and prompts that are not optimized for the particular workload, leading to unnecessary computational overhead and inconsistent decision quality.

Fourth, existing systems usually do not integrate continuous safety evaluation into the control flow of the generative model. Although some systems may compute risk scores, these scores are often not used to dynamically adjust the content and level of detail of generated responses or to control when warning information or reassurance information should be output. Consequently, the human-machine interaction layer is not driven by a technically meaningful internal state, which limits the system's ability to allocate computational and communication resources where they are most needed, and prevents fine-grained escalation or de-escalation based on live data.

Therefore, there is a need for an improved computer-implemented system and method that: (i) performs integrated audio acquisition, preprocessing, and text analysis with continuous threat scoring; (ii) constructs and updates prompt sentences for a generative information processing model based on real-time analysis results and safety indices; (iii) uses the generative model output to control both machine actions and user interface behaviors; and (iv) stores analysis and response histories for adaptive refinement of the threat evaluation and prompt construction logic. By addressing these technical problems, the computer system can improve accuracy and stability of threat detection, reduce unnecessary alerts, and more efficiently utilize computational resources for real-time security interaction processing.

The specific processing by the specific processing unit 290 of the data processing device 12 in Application Example 1 is realized by the following means.

The present invention provides a server comprising a processor configured to acquire and preprocess audio information from one or more input devices, convert the audio information into text information and analyze the text information using natural language processing and classification algorithms, evaluate presence and degree of a threat based on a result of the analysis and update a safety index continuously as additional audio information is received, construct a prompt sentence for a generative information processing model based on the result of the analysis and the safety index, the prompt sentence including instruction information indicating a response policy to the threat, input the prompt sentence into the generative information processing model to generate response information, determine response content to be presented to a user or a communication partner based on the response information, control output of the response content as text information and as audio information generated by an audio synthesis process, and store the result of the analysis, the response information, and past case information in a storage device and update, in a learning manner, parameters for the threat evaluation and a configuration of the prompt sentence based on the stored information. This enables a computer-centric improvement in which the server dynamically couples low-level audio and text analysis with high-level generative processing, adaptively modifies prompts and responses according to real-time safety indices, and incrementally refines internal models and prompt structures using historical interaction data, thereby increasing technical accuracy and robustness of threat detection, reducing computational waste due to static or misaligned prompts, and improving efficiency and reliability of automated security interaction processing.

The term “audio information” refers to data representing sound captured from an environment, including but not limited to human speech, ambient noise, and signals from acoustic sensors, in analog or digital form.

The term “preprocess” refers to performing one or more signal-processing or data-conditioning operations on acquired data, such as filtering, noise reduction, normalization, segmentation, or source separation, prior to further analysis.

The term “text information” refers to symbolic data representing linguistic content obtained from audio information or other sources, including characters, words, sentences, or structured text segments.

The term “analyze the text information” refers to applying computational techniques, including natural language processing, linguistic parsing, pattern recognition, or statistical classification, to extract semantic, syntactic, or pragmatic features from the text information. The term “threat” refers to a potential or actual harmful event or malicious intent, including but not limited to security incidents, fraudulent activities, or other risky situations inferred from analyzed information.

The term “safety index” refers to a numerical or categorical indicator that represents an estimated level of risk or safety associated with an interaction, conversation, or situational context, and that is updated over time as new information is processed.

The term “prompt sentence” refers to a structured input sequence, including instructions, context, and constraints, constructed for presentation to a generative information processing model to cause the model to produce response information.

The term “generative information processing model” refers to a computational model, such as a machine learning model or a neural network, configured to generate output data, including text or other symbolic information, in response to input data such as a prompt sentence. The term “response information” refers to data generated by the generative information processing model, including recommendations, instructions, summaries, notifications, or other content derived from the input prompt sentence.

The term “response content” refers to information selected, adapted, or formatted based on the response information for presentation to a user or a communication partner, including text displays, synthesized speech, or other output modalities.

The term “audio synthesis process” refers to a computational procedure that converts text information or symbolic representations into audio information, including but not limited to text-to-speech conversion.

The term “communication partner” refers to an entity, such as a human user or an external device, that participates in an interaction or exchange of information with the system via a communication medium.

The term “communication medium” refers to a physical or logical channel for transmitting information, including wired networks, wireless networks, telecommunication lines, or any combination thereof.

The term “storage device” refers to a hardware or virtual component configured to store data, including volatile or non-volatile memory, magnetic or optical storage, or network-attached storage systems.

The term “past case information” refers to stored data associated with previous interactions, incidents, or events, including transcripts, analysis results, response information, outcomes, and metadata.

The term “learning manner” refers to a process in which parameters, models, or configurations are updated based on accumulated data, including but not limited to machine learning, statistical optimization, or rule adaptation.

The term “threat evaluation” refers to a computational operation that estimates the existence, type, and severity of a threat based on analysis results, safety indices, and optionally past case information.

The term “configuration of the prompt sentence” refers to a selection and arrangement of components included in the prompt sentence, such as contextual descriptions, detected categories, numerical indices, instructions, and desired output formats.

The term “operation items selectable by the user” refers to user interface elements, such as buttons, menu entries, or interactive controls, that correspond to actions or options derived from the response information and that can be explicitly chosen by the user.

The term “warning information” refers to output data intended to alert a user or system component to an elevated level of risk, including notifications, messages, signals, or other indications triggered when the safety index exceeds a threshold.

The term “summary and evaluation result of an interaction” refers to condensed information describing content, course, and system assessment of a communication session, including key events, risk levels, and final conclusions about the interaction.

In one embodiment, a server, one or more terminals, and a user cooperate to implement the invention.

The server includes at least one processor, a memory, a network interface, and a storage device. The server executes software modules including an audio preprocessing module, a speech-to-text module, a text analysis module, a threat evaluation module, a prompt construction module, a generative AI interaction module, a response control module, a text-to-speech module, a safety index management module, and a learning/update module. The terminals include at least one processor, a microphone, a speaker, a display, and a communication interface, and execute a client application that communicates with the server. The terminal uses an operating system audio interface such as an audio recording API of a mobile operating system to capture audio information from the microphone. The terminal optionally applies local echo cancellation and gain control, and then transmits audio frames in a digital format (for example, linear PCM frames) to the server via a network connection. By streaming short frames, the terminal reduces latency and enables the server to start processing before complete utterances are finished, thereby improving end-to-end reaction time. The server receives audio frames through the network interface and stores the frames in a buffer in the memory. The server applies digital signal processing using signal-processing software such as a general-purpose multimedia library or a scientific computation library. The server performs band-pass filtering to emphasize frequency components commonly associated with human speech (for example, between approximately 300 Hz and 3400 Hz), spectral subtraction or similar methods to reduce stationary background noise, and, in a multi-speaker environment, source separation using a neural network-based separation model. These preprocessing operations transform the raw audio into a representation with higher signal-to-noise ratio, which directly improves the accuracy of subsequent recognition and reduces the number of misclassified threats.

The server converts the preprocessed audio information into text information using a speech recognition engine. The server uses an acoustic model and a language model implemented as deep neural networks. For example, the acoustic model may be a recurrent or transformer-based network trained on time-frequency features such as Mel-frequency cepstral coefficients, and the language model may be a transformer-based network trained on large-scale text corpora. The server computes probabilities over phoneme or subword sequences for each frame and applies a decoding algorithm such as beam search with a lexicon and language model scores to generate transcription hypotheses. The server selects the most probable hypothesis as the recognized text and associates timestamps and, when available, speaker labels. By using these models and decoding algorithms, the server reduces word error rate compared with rule-based or simpler statistical models, which in turn increases the reliability of the threat evaluation.

The server analyzes the text information using the text analysis module. The server tokenizes the text into sentences and words, performs part-of-speech tagging, and constructs dependency trees using a syntactic parser. The server extracts features such as n-grams, syntactic patterns, named entities (for example, locations, persons, organizations), sentiment scores, and discourse markers indicating urgency or conditional threats. The server then encodes the text using a transformer-based encoder model, which produces vector representations (embeddings) for sentences or segments. These embeddings capture semantic similarity beyond direct keyword matching.

The server evaluates the existence and degree of a threat using the threat evaluation module. The server feeds the embeddings and additional features (such as counts of suspicious phrases, presence of time expressions, or references to restricted areas) into a classifier. In one embodiment, the classifier is a neural network comprising multiple fully connected layers with nonlinear activation functions, trained to output probabilities for multiple threat categories, for example “no threat,” “fraud attempt,” “intrusion plan,” or “explosive threat.” The server computes a threat probability distribution and selects a primary category and a numerical score. The server then combines this score with anomaly detection outputs, for example from an autoencoder trained on benign conversations, and with similarity scores against a database of past case information. The server stores vector representations of past incidents in a specialized vector index and computes similarity measures such as cosine similarity between the current embedding and stored embeddings. By combining classifier output, anomaly scores, and similarity scores, the server derives a safety index that is more robust than a single scalar probability and that changes over time as new segments of the interaction arrive.

The server manages the safety index in the safety index management module. The server updates the safety index by applying a time-weighted function or Bayesian-style update. For example, the server may maintain prior and likelihood values for different threat categories and update posterior probabilities when new text segments are analyzed. The server maintains the safety index in the memory for fast access and persists snapshots of the index in the storage device with references to the corresponding conversation segments. This continuous update allows the system to react quickly to escalating or de-escalating situations and to use the updated index to control downstream processing.

The server constructs a prompt sentence for a generative AI model using the prompt construction module. The server stores prompt templates in a structured data format, for example as records containing fixed textual segments and placeholders for dynamic values such as threat type, safety index value, location, time, and relevant transcript excerpts. The server fills these placeholders with current values. In one embodiment, the server generates a prompt sentence such as:

“Context: A conversation was captured near an entrance of a building.

Transcript: ‘We will break into the store through the back door tonight.’

Detected threat type: possible intrusion.

Risk score (safety index): 0.91 (high).

Historical similarity: similar to previous after-hours break-in incidents.

Task: As a security operations expert, propose the most effective immediate and follow-up response actions. Return (1) a short summary, (2) a numbered list of concrete actions for the on-site security team, and (3) a concise notification message for the facility manager.”

The server, in another scenario, generates a prompt sentence such as:

“Detected threat type: bomb threat.

Context: An anonymous caller mentioned an ‘explosive device in the parking lot’ without specifying the exact location.

Audience: facility staff (non-technical).

Task: Generate an appropriate notification message that is calm, instructive, and avoids causing panic, while clearly instructing staff on immediate safety actions.”

The server may compress or summarize long transcript segments using a summarization model before inserting them into the prompt sentence so that the input remains within model-specific token limits. By encoding the safety index and selected contextual details into the prompt sentence in a structured and dynamic manner, the server enables the generative AI model to produce responses that are sensitive to real-time risk and system state, instead of relying on static, manually defined prompts.

The server interacts with the generative AI model in the generative AI interaction module. The server implements a generative language model as a multi-layer transformer network with self-attention mechanisms. The model is trained on large corpora of text with an objective such as minimizing negative log-likelihood of predicting the next token in a sequence. During inference, the server feeds the tokenized prompt sentence into the model, obtains hidden state vectors through successive transformer blocks, and computes output token probabilities. The server samples or selects tokens according to decoding strategies such as greedy decoding, beam search, or top-k/top-p sampling, thereby generating response information in textual form.

The server trains or fine-tunes at least part of the generative model on domain-specific data, including archives of past security incidents and preferred response styles. The server uses a loss function that penalizes divergence from reference responses and can incorporate additional penalties for unsafe or incomplete recommendations. The server uses gradient-based optimization methods such as stochastic gradient descent or adaptive optimization to update model parameters. The server may apply data augmentation techniques to generate paraphrased examples or to simulate variations in threat language. By providing this training and fine-tuning, the server adapts the generative model to the specific security domain, thereby improving the accuracy and consistency of generated response information compared to generic, unadapted models.

The server determines response content using the response control module. The server parses the raw response information from the generative model and maps sections of the generated text to internal fields such as “summary,” “actions for guard,” or “notification for manager.” The server may enforce rules to ensure that minimal safety requirements are always included. For example, the server checks that the actions list includes certain mandatory steps when the safety index exceeds a high threshold and, if not, adds those steps via a rule-based engine. The server also translates response items into structured actions that the terminal can present as selectable options, such as “Dispatch personnel to Entrance 3,” “Lock back door of Store area,” or “Zoom camera in specified zone.” This mapping from free text to structured actions uses additional classification or pattern-matching logic and allows the system to drive real-world devices and workflows rather than only present unstructured text.

The server converts selected response content into audio information using the text-to-speech module. The server uses a text-to-speech engine that includes an acoustic model and a vocoder. The acoustic model maps input text to a sequence of intermediate acoustic parameters, such as mel-spectrogram frames, and the vocoder converts these parameters into time-domain audio waveforms. The server applies prosody control parameters based on urgency or role (for example, a more neutral tone for managers and a more directive tone for on-site guards). The server outputs audio frames to the terminal over the network. The terminal receives the response content and associated audio information from the server. The terminal stores the received data temporarily in its memory and uses the speaker and audio playback interface to output the audio to the user. The terminal also displays the response content on the display as textual guidance and interactive elements. The terminal shows, for example, the summary of the situation, the current safety index, and buttons corresponding to actions derived from the response information. The user can select these operation items to confirm actions, defer them, or override them. The terminal sends the user's selections and any manually entered notes back to the server, which records them with timestamps as part of the past case information.

The server uses the learning/update module to improve the threat evaluation and prompt configuration over time. The server periodically retrieves stored past case information, including transcripts, safety index trajectories, generated responses, executed actions, and final outcomes. The server labels these records based on user feedback and actual incident results. The server retrains or fine-tunes the classifier and generative model using these labeled data. The server adjusts the mapping between safety index ranges and prompt template selection, for example increasing the level of detail in prompts when certain patterns of escalation have been observed to lead to critical incidents. The server updates rules and parameters used to construct prompt sentences and to post-process response information. Through these iterative updates, the server optimizes internal parameters and data flows to reduce false positives and false negatives, improve model calibration, and increase the relevance and clarity of generated responses.

The server, by tightly integrating audio preprocessing, advanced speech recognition, multi-feature text analysis, dynamic safety index computation, structured prompt sentence construction, specialized generative modeling, and feedback-driven learning, improves the technical functioning of the overall computing system. The server reduces redundant network traffic by compressing and summarizing transcript segments before sending them to the generative model, thereby lowering communication overhead between internal modules. The server decreases processing time by starting analysis on partial audio segments and by reusing cached embeddings for previous segments. The server improves data management by storing vector representations and structured incident records in a way that supports efficient similarity search and time-series analysis. These features are not merely automation of human judgment; instead, they change how the computer allocates computational resources, how it structures model inputs and outputs, and how it adapts internal data structures and parameters based on technical performance metrics.

The system further provides technical effects in real-world environments. The server can control external devices via terminals, such as adjusting surveillance camera zoom levels, triggering access control mechanisms, and prioritizing communication channels, based on structured actions derived from the generative AI model output. The terminal, in turn, acts as a bridge between the server and physical sensors and actuators through its microphone, speaker, display, and communication interface. As a result, the invention is rooted in computer technology and device control, and the improved algorithms for threat evaluation, prompt construction, and generative interaction directly enhance system-level performance in terms of detection accuracy, latency, and communication efficiency.

Alternative embodiments are possible. The server may implement different neural network architectures for the text analysis module, such as convolutional neural networks or hybrid recurrent-transformer architectures, and may use different loss functions, such as margin-based losses or multi-task losses that jointly optimize classification and similarity estimation. The server may maintain multiple safety indices for different dimensions of risk, such as physical threat, financial fraud, or privacy violation, and may construct separate prompt sentences for each dimension. The server may also vary decoding strategies in the generative model, for example using constrained decoding to ensure that specific mandatory phrases or warnings are included under certain conditions. The terminal may be implemented as a dedicated security console, a handheld communication device, or an integrated module embedded in a surveillance system. In each case, the server, the terminal, and the user cooperate in substantially the same manner to realize the technical advantages of the invention.

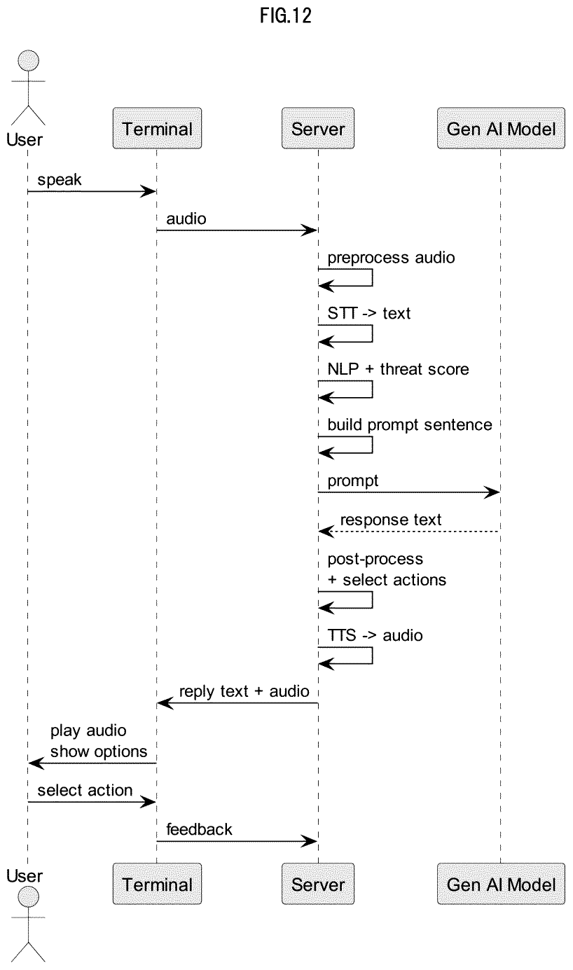

The following describes the processing flow using FIG. 12.

### Step 1:

The terminal captures audio information and transmits it to the server.

The terminal uses a microphone to receive analog sound waves from an environment, including user speech and ambient noise, and converts the analog signal into digital audio samples at a fixed sampling rate. As input, the terminal obtains raw analog audio and device metadata such as device ID and location. The terminal performs basic preprocessing, such as automatic gain control and echo cancellation, to normalize volume and reduce feedback. The terminal segments the digital audio into frames of a predetermined duration and encapsulates the frames with timestamps and metadata into network packets. As output, the terminal generates a stream of timestamped digital audio frames and sends the stream to the server via a network interface using a secure communication protocol.

### Step 2:

The server receives and buffers the audio frames.

The server accepts, as input, the stream of digital audio frames and associated metadata from the terminal through a network interface. The server validates packet integrity, reconstructs the correct chronological order of frames using timestamps, and writes the frames into a memory buffer associated with a session identifier. The server stores basic session information, such as terminal ID, user ID (if available), and capture location, in a session record in a storage device. As output, the server maintains an in-memory audio buffer organized as a sequence of frames ready for signal processing, and a corresponding session record for tracking analysis state.

### Step 3:

The server performs audio preprocessing to improve signal quality.

The server reads, as input, the buffered audio frames from memory and applies digital signal processing operations. The server computes frequency-domain representations of the frames using a fast Fourier transform, and applies a band-pass filter to attenuate frequencies outside a predefined speech-relevant range. The server estimates noise spectral characteristics from non-speech portions and performs noise reduction, for example by spectral subtraction, to suppress background noise. In multi-speaker environments, the server applies a source separation model to decompose the mixed signal into separate component signals. The server converts the processed frequency-domain frames back to time-domain samples. As output, the server generates a sequence of enhanced audio frames with improved signal-to-noise ratio and stores these frames in a separate buffer for speech recognition.

### Step 4:

The server converts the enhanced audio information into text information.

The server takes, as input, the enhanced audio frames and feeds them into a speech recognition engine that includes an acoustic model and a language model. The server computes acoustic feature vectors, such as Mel-frequency cepstral coefficients, for each short-time window and passes these feature vectors through the acoustic model to obtain posterior probabilities over phonetic or subword units. The server combines these probabilities with language model scores using a decoding algorithm such as beam search to generate candidate transcriptions. The server selects the most probable transcription sequence and segments it into words and sentences with timestamps. As output, the server produces text information representing the recognized speech, together with alignment data between text segments and time ranges, and stores this information in a transcript data structure.

### Step 5:

The server analyzes the text information using natural language processing.

The server receives, as input, the transcript data structure containing text segments and timestamps. The server tokenizes the text into sentences and tokens, assigns part-of-speech tags to each token, and constructs dependency trees to capture syntactic relations between words. The server performs named entity recognition to identify entities such as locations, dates, and persons, and computes additional features such as n-gram counts, sentiment indicators, and markers of urgency or conditional intent. The server encodes sentences into numerical vector representations using a transformer-based encoder, producing dense embeddings that capture semantic meaning. As output, the server generates an annotated text representation that includes tokens, syntactic structures, entities, feature vectors, and embeddings, and stores this representation for threat evaluation.

### Step 6:

The server evaluates the presence and degree of a threat and updates a safety index.

The server takes, as input, the annotated text representation and associated embeddings from the previous step. The server feeds the embeddings and derived features, such as occurrence of suspicious phrases and presence of explicit threat patterns, into a classification model configured to output probabilities for different threat categories. The server calculates a threat probability distribution and selects a primary category along with a numerical threat score. The server queries a vector index that stores embeddings of past case information and computes similarity metrics, such as cosine similarity, between the current embedding and stored embeddings. The server combines the threat score, similarity metrics, and optional anomaly detection scores using a weighted aggregation function to compute an updated safety index. As output, the server produces a safety index value and a threat category label and records these in an internal safety index record linked to the session.

### Step 7:

The server manages the safety index over time as new segments arrive.

The server receives, as input, successive safety index values and threat category outputs for new transcript segments within the same session. The server applies a time-dependent update rule, such as an exponential moving average or a Bayesian update, to combine the previous safety index with the new evidence. The server also evaluates trends by comparing the current value against historical values to detect escalation or de-escalation. The server stores the updated safety index and trend information in the session record. As output, the server maintains a continuously updated safety index that reflects the evolving risk level of the interaction and is accessible to other modules for prompt construction and response control. Step 8:

The server constructs a prompt sentence for the generative AI model.

The server takes, as input, the latest transcript excerpts, the threat category, the current safety index, relevant named entities, and similarity references to past cases from the session record. The server selects an appropriate prompt template based on factors such as threat type and safety index range, where each template defines fixed text segments and placeholders for dynamic data. The server fills the placeholders with current values, optionally summarizing long transcript portions using a summarization routine to fit model constraints. The server, for example, generates a prompt sentence such as:

“Context: A conversation was captured near an entrance of a building.

Transcript: ‘We will break into the store through the back door tonight.’

Detected threat type: possible intrusion.

Risk score (safety index): 0.91 (high).

Historical similarity: similar to previous after-hours break-in incidents.

Task: As a security operations expert, propose the most effective immediate and follow-up response actions. Return (1) a short summary, (2) a numbered list of concrete actions for the on-site security team, and (3) a concise notification message for the facility manager.” As output, the server produces a fully constructed prompt sentence in text form and passes this prompt to the generative AI interaction module.

### Step 9:

The server generates response information using the generative AI model.

The server receives, as input, the constructed prompt sentence. The server tokenizes the prompt into a sequence of tokens and feeds the tokens into a generative AI model implemented as a multi-layer transformer network. The server computes attention-weighted hidden states layer by layer and obtains output probability distributions for subsequent tokens. The server applies a decoding strategy such as beam search or top-k sampling to select output tokens step by step, forming a generated text sequence. The server interprets the generated sequence as response information, which can include a summary, a list of recommended actions, and notification messages. As output, the server creates a structured response information object that organizes the generated text into labeled sections and stores this object for subsequent processing.

### Step 10:

The server post-processes the response information and decides response content. The server takes, as input, the structured response information object and the current safety index and threat category. The server parses the generated text sections and maps recommended actions to internal action types, such as dispatching personnel, adjusting monitoring devices, or sending alerts. The server applies rule-based validation to ensure compliance with predefined safety policies, for example by verifying that, for high-risk scenarios, certain minimal actions are recommended. The server modifies or supplements the action list if necessary. The server formats the validated actions and messages into response content suitable for terminal presentation, including human-readable instructions and metadata indicating priority and urgency. As output, the server generates a response content package that includes textual instructions, action identifiers, and display configurations.

### Step 11:

The server converts the response content into audio information for playback. The server receives, as input, the textual parts of the response content and associated parameters such as language, voice profile, and urgency level. The server sends the text to a text-to-speech engine that converts the text into intermediate acoustic features and then into waveform samples. The server may adjust prosody parameters to emphasize urgency or clarity, based on the safety index and the role of the intended listener. As output, the server produces synthesized audio data corresponding to the response content and bundles it with the original text and control metadata, forming a response payload for transmission to the terminal.

### Step 12:

The terminal presents the response content to the user and collects feedback.

The terminal takes, as input, the response payload containing synthesized audio, text, and action metadata from the server via the network interface. The terminal stores the payload temporarily and uses a playback interface to convert the audio data into analog signals for output through the speaker. The terminal displays the textual response content on the display, including the summary, the current safety index, and selectable operation items corresponding to structured actions. The user listens to the audio, reads the displayed text, and selects one or more operation items, or enters comments or confirmations through an input interface. As output, the terminal generates user feedback data including selected actions, timestamps, and any textual notes, and transmits this feedback to the server.

### Step 13:

The server records interaction outcomes and updates learning data.

The server receives, as input, the user feedback data, including selected actions and comments, and links this data to the corresponding session record and safety index history. The server stores the combined information as past case information in the storage device, including transcripts, safety indices, generated response information, executed actions, and eventual outcomes. The server labels these records using the feedback (for example, “appropriate response” or “overcautious”) and periodically aggregates them into training datasets. As output, the server produces updated training and evaluation datasets that are used to retrain or fine-tune the threat evaluation model and to adjust rules and templates for prompt sentence construction, thereby improving future processing accuracy and efficiency.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional fraud-detection systems that monitor voice communications typically perform only shallow analysis of textual content, such as keyword matching or coarse classification of entire conversations. Such systems often ignore nuanced contextual cues across an evolving conversation and cannot adequately reflect the dynamic psychological state of the user. As a result, these systems either over-alert, thereby causing alert fatigue and user distrust, or under-alert, thereby failing to intervene when the user is under pressure and most vulnerable.

Additionally, traditional architectures treat fraud-risk estimation, emotion estimation, and response generation as isolated components. Fraud-risk models may output a score, but that score is not tightly integrated with how system prompts are formulated for downstream generative components, or how guidance is presented in real time during a live call. Emotion-detection modules, when present, are often monomodal (for example, text-only or audio-only) and are not fused with fraud-risk indicators in a principled, machine-processable way. This leads to suboptimal and inconsistent decisions regarding when and how to warn users or what specific questions to suggest.

Furthermore, many existing systems rely on fixed, preauthored templates for user guidance and counterpart questioning. Static templates cannot adapt to the specific linguistic content, risk level, and user emotion present in a given conversation. Such rigidity limits the ability of the system to provide fine-grained, context-aware interventions, and also constrains extensibility, because adding new scenarios or refining behaviors requires manual authoring and deployment of additional templates.

From a computer-technology standpoint, there is also a lack of an integrated processing pipeline that: (i) transforms streaming multimodal data (audio and text) coming from a communication terminal into structured, machine-usable risk and emotion indicators; (ii) uses these indicators to automatically construct prompt sentences tailored for a generative AI model; and (iii) feeds the generative output back into the communication loop in real time with policy-based filtering and adaptive synthesis parameters. Without such an integrated architecture, system implementers face increased complexity, fragmented state management, and inefficient use of computing resources.

Accordingly, there is a need for an improved computer-implemented system that, in a unified processing architecture, receives streaming audio from a communication terminal, converts and annotates that audio as text, computes a fraud-risk indicator by combining machine-learning classification with dictionary-based analysis, computes an emotion state vector by fusing audio-based and text-based emotion scores, and then uses these indicators to dynamically generate and filter prompt sentences and response texts via a generative AI model. There is a further need for such a system to automatically adapt speech-synthesis parameters and guidance content in real time based on the computed emotion state vector, and to log user actions as feedback data for continuous model improvement.

The specific processing by the specific processing unit 290 of the data processing device 12 in Example 2 is realized by the following means.

The present invention provides a server comprising a processor configured to receive, from a communication terminal, audio information corresponding to a communication session, convert the audio information into text information by using speech recognition, associate the text information with identification information of the communication session, and store the text information and the identification information; perform natural language processing on the text information, the natural language processing including morphological analysis and keyword detection, calculate a fraud risk indicator indicating a probability that the text information is related to fraudulent activity by using a classification model based on machine learning and an auxiliary score based on a dictionary of dangerous expressions, and store the fraud risk indicator in association with the identification information; extract acoustic feature quantities from the audio information related to a user, input the acoustic feature quantities into an audio emotion recognition model to calculate audio-based emotion scores, input the text information related to the user into a text emotion analysis model to calculate text-based emotion scores, and integrate the audio-based emotion scores and the text-based emotion scores to generate an emotion state vector representing an emotional state of the user; determine, on the basis of the fraud risk indicator and the emotion state vector, a safety level for the communication session and recommended actions to be presented to the user, and store the safety level and the recommended actions in association with the identification information; generate a prompt sentence for a generative AI model on the basis of at least the text information, the fraud risk indicator, the safety level, the emotion state vector, and a conversation history, the prompt sentence explicitly describing a current risk situation, the emotional state of the user, and a type and expression conditions of a response to be generated; input the prompt sentence into the generative AI model, obtain from the generative AI model a response text including at least one question text directed to a counterpart and at least one explanation text directed to the user, perform filtering on the response text including checking for prohibited expressions and length limitations, and generate a verified response text; transmit the verified response text, the safety level, and the recommended actions to the communication terminal so that the communication terminal presents, by at least one of a display device and a voice output device, guidance to the user and the counterpart and operation instructions concerning continuation or termination of the communication session; and collect action history information indicating actions executed by the user based on the guidance, including at least call termination and contact to a third party, and store the action history information in association with the fraud risk indicator and the emotion state vector. This enables an integrated computer-implemented pipeline that improves the technical functioning of the fraud-detection system by jointly modeling fraud risk and user emotion, automatically constructing and filtering prompt sentences for a generative AI model, dynamically adapting response content and synthesized speech parameters during live calls, and using logged user actions to continuously refine underlying models and response generation policies.

The term “communication terminal” refers to an information processing device operated by a user, including but not limited to a mobile device, a stationary device, or a general-purpose computing device, that is configured to perform voice input and output, network communication, and interaction with a server during a communication session. The term “audio information” refers to digital data representing sound captured during a communication session, including at least voice signals of a user and a counterpart, which may be obtained by sampling an analog signal from a microphone and encoding the sampled data in a predetermined format.

The term “text information” refers to character-based data generated from audio information by speech recognition or provided by another input method, the text information representing linguistic content of utterances made during a communication session.

The term “identification information” refers to data that uniquely identifies a communication session within the system, such as a session identifier, call identifier, or other unique key used to associate audio information, text information, and processing results.

The term “speech recognition” refers to a computational process that converts audio information into text information by applying an acoustic model and a language model to infer linguistic units such as phonemes, words, and sentences.

The term “natural language processing” refers to a set of computer-implemented operations performed on text information, including at least tokenization, morphological analysis, keyword detection, and other linguistic analyses, to derive structured representations suitable for further machine processing.

The term “morphological analysis” refers to a natural language processing operation that segments text information into morphemes or tokens and assigns linguistic attributes such as part of speech, base form, and inflectional information to each segment.

The term “keyword detection” refers to a processing operation that searches text information for the presence of predetermined words, phrases, or patterns, and determines positions, frequencies, or contextual usage of such words, phrases, or patterns.

The term “classification model” refers to a machine learning model, implemented in software and executed by a processor, that receives a representation of text information as input and outputs a probability distribution or score indicating membership of the input in one or more predefined classes.

The term “fraud risk indicator” refers to a numerical value or structured score computed by combining outputs of a classification model and auxiliary scoring processes, the numerical value or structured score indicating a probability or degree that the text information is related to fraudulent activity.

The term “dictionary of dangerous expressions” refers to a data structure stored in a memory device, containing a plurality of predefined words, phrases, or patterns that are statistically or heuristically associated with fraudulent activity, each entry optionally having an associated weight or attribute.

The term “auxiliary score” refers to a numerical value calculated on the basis of occurrences or patterns of dangerous expressions in text information and weighting information associated with the dangerous expressions, the numerical value being used to supplement a score from a classification model.

The term “acoustic feature quantities” refers to numerical descriptors computed from audio information, such as spectral coefficients, cepstral coefficients, energy measures, pitch-related parameters, or other signal-processing features used as input to an emotion recognition model. The term “audio emotion recognition model” refers to a machine learning model that receives acoustic feature quantities as input and outputs scores or probabilities corresponding to one or more emotional categories, such as anxiety, calmness, confusion, fear, or anger.

The term “text emotion analysis model” refers to a machine learning model that receives text information as input and outputs scores or probabilities corresponding to one or more emotional categories inferred from linguistic expressions, such as anxiety, confusion, anger, or neutrality.

The term “audio-based emotion scores” refers to numerical values generated by an audio emotion recognition model that quantify degrees of one or more emotional states inferred from acoustic feature quantities.

The term “text-based emotion scores” refers to numerical values generated by a text emotion analysis model that quantify degrees of one or more emotional states inferred from text information.

The term “emotion state vector” refers to a data structure, representable as a vector of numerical components, whose elements indicate integrated degrees of one or more emotional states of a user, the data structure being generated by combining audio-based emotion scores and text-based emotion scores.

The term “safety level” refers to a categorical or graded indication, derived from at least a fraud risk indicator and an emotion state vector, representing an overall assessment of safety or danger associated with a communication session.

The term “recommended actions” refers to one or more machine-generated suggestions for user behavior, such as ending a call, requesting additional verification from a counterpart, refraining from financial transactions, or consulting a third party, the suggestions being determined on the basis of a safety level and other indicators.

The term “conversation history” refers to accumulated text information and associated metadata for utterances that have occurred during a communication session, including at least speaker identifiers and temporal ordering, and used as context for subsequent processing. The term “prompt sentence” refers to a structured textual input prepared for a generative AI model, the structured textual input describing at least a current risk situation, an emotional state of a user, and a type and expression conditions of a response to be generated.

The term “generative AI model” refers to a machine learning model having natural language generation capability, such as a neural network-based language model, which receives a prompt sentence as input and outputs one or more candidate response texts.

The term “response text” refers to text generated by a generative AI model on the basis of a prompt sentence, the text including at least one question text directed to a counterpart or at least one explanation text directed to a user.

The term “question text” refers to a portion of response text that is formulated as one or more interrogative sentences intended to be presented to a counterpart in order to verify identity, clarify intent, or otherwise reduce uncertainty.

The term “explanation text” refers to a portion of response text that is formulated as one or more declarative sentences intended to be presented to a user in order to explain a risk situation, a safety level, or recommended actions in an understandable manner. The term “filtering” refers to a processing operation performed on response text to detect and, when necessary, modify, reject, or regenerate content that violates predetermined constraints, including at least constraints on prohibited expressions and length limitations.

The term “verified response text” refers to response text that has been subjected to filtering and determined to meet predetermined constraints, such that the response text is approved for presentation to a user or a counterpart.

The term “display device” refers to a hardware component of a communication terminal or other device that provides visual output, such as a screen, monitor, or panel, used to present text, symbols, or graphical indicators to a user.

The term “voice output device” refers to a hardware component capable of outputting audio signals, such as a speaker, earpiece, or headset, used to present synthesized speech or other audio information to a user or a counterpart.

The term “speech synthesis engine” refers to a software and hardware combination configured to convert text information into audio information representing synthesized speech, with controllable parameters such as speaking rate, pitch, and intonation.

The term “agent response” refers to an audio output generated by the system, based on verified response text, and transmitted to a counterpart through a communication path as if it were spoken by the user.

The term “operation instructions concerning continuation or termination of the communication session” refers to guidance presented to the user, including explicit suggestions or options to maintain, hold, or end a communication session, based on computed safety levels and recommended actions.

The term “action history information” refers to logged data indicating actions executed by a user in response to guidance or system outputs, including at least call termination events, initiation of contact with a third party, or other relevant operations.

The term “third party” refers to an entity other than the user and the counterpart in a communication session, such as a trusted individual, a support organization, or an official contact point, that the user may contact in response to system guidance.

The term “generation policy” refers to one or more internal rules, parameters, or strategies that control how prompt sentences are constructed and how a generative AI model is configured or constrained in generating response text.

The term “update” refers to a process in which parameters of at least one machine learning model, such as a classification model or an emotion recognition model, are modified based on additional training data, including action history information, to improve model performance or adapt behavior.

In one embodiment, a system includes a server and one or more terminals connected via a communication network. The server comprises at least one processor, a main memory, a non-volatile storage device, and a network interface. The terminal comprises at least one processor, a memory, a microphone, an audio output device, a display device, and a network interface. The server and the terminal execute respective application programs stored in the memory, and cooperate to implement fraud-risk evaluation, emotion-state estimation, prompt sentence generation, and response generation using a generative AI model.

### A. Overall Hardware and Software Configuration

Server uses a general-purpose processor, such as a multi-core central processing unit conforming to a standard instruction set, and optionally a graphics processing unit or other accelerator for neural network inference. Server runs a general-purpose operating system, such as a UNIX-like operating system, and executes an application framework, for example a web application framework conforming to HTTP. Server stores, in a non-volatile storage device such as a solid-state drive, software modules including: a speech recognition client library, a natural language processing library, a morphological analyzer such as a Japanese morphological analysis engine, a machine-learning library such as a tensor computation library, a generative AI model, and one or more emotion recognition models.

Terminal uses a processor such as a mobile system-on-chip, and runs a mobile operating system such as a smartphone operating system. Terminal executes an application that accesses telephony functions through an operating system telephony interface, accesses an audio input interface to capture in-call audio, and accesses an audio output interface and a text-to-speech interface to produce audio guidance. Terminal executes a network communication library supporting encrypted communication with the server, for example using transport layer security.

### B. Data Structures and Internal Representations

Server stores, in main memory, session data structures keyed by a call identifier. For each communication session, server maintains data fields including:
(a) a list of utterance records, each utterance record containing at least: speaker label (user or counterpart), text string, start time, end time, and token sequence;
(b) a fraud-risk indicator, represented as a floating-point value in a predetermined range, and optionally a fraud-type label;
(c) audio-based emotion scores and text-based emotion scores, each represented as vectors of floating-point values indexed by emotion categories;
(d) an emotion state vector, represented as a fixed-length vector of floating-point values, each element corresponding to a normalized degree of a particular emotional state;
(e) a safety level, represented as an enumerated value; and
(f) recommended actions, represented as an array of action codes and associated textual descriptions.

Terminal maintains, in its own memory, a local data structure for the active call, including raw audio buffers, recognized text segments, and received response texts.

### C. Natural Language Processing and Fraud-Risk Evaluation

Server performs natural language processing on text information obtained from the terminal. Server uses a morphological analyzer to segment input text into tokens corresponding to morphemes and to assign part-of-speech tags and base forms. Server then uses a tokenizer compatible with a transformer-based language model to convert the token sequence into subword units and numerical identifiers. Server constructs a tensor representation of the input text, including an identifier sequence and attention masks, and feeds the tensor into a neural-network-based classification model stored in the memory.

Server uses a classification model having a layered architecture, for example a transformer encoder comprising multiple layers of self-attention and feed-forward units. Server stores trained weight parameters, such as attention weights and projection matrices, which define how the model maps token sequences to contextual embeddings and then to output logits. Server computes a fraud-related probability by applying a softmax or logistic function to the logits. This computation converts internal activation values into a floating-point fraud-risk score.

Server further uses a dictionary of dangerous expressions stored in a structured format. This dictionary associates predefined expressions with respective weight values. Server performs keyword detection by scanning the text information for occurrences of the expressions using pattern matching, including character-based and word-based comparisons. Server computes an auxiliary score by multiplying occurrence counts by the corresponding weights and summing the results. Server then combines the probability from the classification model and the auxiliary score using a predetermined formula, for example a weighted linear combination followed by normalization. This combination improves accuracy by compensating for cases in which rare but highly indicative expressions appear that may not be fully captured by the learned model.

Because server performs tokenization, dictionary lookup, neural-network inference, and score fusion in a coordinated data flow, server reduces redundant passes over the data and minimizes memory transfers between modules. This leads to improved processing speed and reduced computational load compared to an architecture where each component operates independently with separate parsing and representation.

### D. Emotion-State Estimation and Multimodal Fusion

Server receives acoustic feature quantities representing user audio from the terminal. Terminal computes such acoustic feature quantities, for example Mel-frequency cepstral coefficients, energy values, and pitch-related parameters, by applying discrete Fourier transform, filter-bank processing, and logarithmic compression to frames of digital audio samples captured from the microphone. Terminal packages these feature vectors with timestamps and the call identifier and transmits them to the server.

Server uses an audio emotion recognition model implemented as a neural network, for example a convolutional or recurrent neural network, which receives a sequence of feature vectors as input. The model includes layers that perform convolution over time, activation functions, pooling, and fully connected projections to produce hidden features. Server applies an output layer with softmax activation to obtain probabilities for multiple emotion classes such as anxiety, calmness, confusion, fear, and anger.

Server also uses a text emotion analysis model. The text emotion analysis model has a similar neural-network architecture to the fraud-risk model, but is trained on corpora labeled with emotional categories. Server feeds tokenized user utterances into the text emotion analysis model to obtain text-based emotion scores. By using separate models trained for fraud classification and emotion classification, server maintains specialized parameter sets that are optimized for distinct tasks.

Server integrates the audio-based emotion scores and the text-based emotion scores to generate an emotion state vector. Server may apply a weighted combination in which weights differ per emotion dimension, or may apply a fusion network that takes concatenated scores as input and outputs a normalized vector. This fusion allows the server to correct for modality-specific noise. For example, server can down-weight text-based confusion when the speech signal is clear but the user uses ambiguous words, or up-weight audio-based anxiety when prosodic features strongly suggest stress.

This multimodal fusion is not a simple automation of human judgment. A human operator typically cannot compute such fused scores in real time across multiple emotion dimensions and sessions. Server uses numeric optimization results obtained during training, including minimization of a loss function such as cross-entropy over labeled multimodal training data, to determine fusion parameters that minimize prediction error. This improves emotion-estimation accuracy and stability compared to manual rules, and thereby enables more reliable subsequent control logic.

### E. Safety-Level Determination and Internal Rule Logic

Server determines a safety level on the basis of the fraud-risk indicator and the emotion state vector. Server executes rule logic or a learned mapping that transforms these numeric indicators into discrete safety categories and recommended actions. The rule logic may include threshold conditions, such as comparing the fraud-risk indicator with multiple threshold values tuned by validation experiments, and combining them with conditions on specific elements of the emotion state vector.

Server, for example, may assign the highest safety alert when both the fraud-risk indicator exceeds a high threshold and the anxiety component of the emotion state vector exceeds a moderate threshold. Server may select more explanatory guidance when the fraud-risk indicator is moderate but confusion is high. These rules are stored as machine-readable configuration data and are applied by the processor deterministically, thereby providing consistent behavior and enabling hardware-level optimization such as branch prediction and cache-efficient evaluation.

### F. Prompt Sentence Generation for the Generative AI Model

Server generates a prompt sentence for the generative AI model by combining conversation history, fraud-risk information, safety level, and emotion state information. Server stores conversation history as a sequence of utterance records, each with a speaker label and timestamp. Server selects a subset of recent utterances according to criteria such as recency and relevance, for example by including the last several utterances from the counterpart and user.

Server constructs a prompt sentence according to a template that defines fixed instruction text and insertion points for variable data. The template may specify that the role of the generative AI model is a protective assistant, that the input section must contain quoted counterpart speech, that the evaluation section must contain numeric fraud-risk and emotion values, and that the task section must describe required output properties. Server inserts text segments representing the conversation, formatted numeric values of the fraud-risk indicator and emotion state vector, and safety level labels at appropriate positions.

For example, when server needs to generate questions for the counterpart, server may construct a prompt sentence such as:

“You are an assistant that helps evaluate potential fraud in phone calls. The caller said: ‘You need to wire JPY 300,000 within today. Please immediately go to the nearest ATM. Please do not tell this to other people.’ Current evaluation: fraud-risk score 0.92 (very high), safety level: very dangerous, user emotion: anxiety 0.85, confusion 0.60. Task:
1. Create three questions in Japanese that the user should politely ask the caller to verify their legitimacy.
2. Use polite style and calm wording that does not increase the user's anxiety.
3. Output only the questions as bullet points.”

When server needs to generate an explanatory message for the user, server may construct a prompt sentence such as:

“You are an assistant that protects users from telephone fraud. The caller said: ‘You need to wire JPY 300,000 within today. Please immediately go to the nearest ATM. Please do not tell this to other people.’ Current evaluation: fraud-risk score 0.92 (very high), safety level: very dangerous, user emotion: anxiety 0.85, confusion 0.60. Task:
1. Create a Japanese message that kindly and clearly explains to the user that this situation is highly likely to be telephone fraud.
2. The user is very anxious and confused, so use calming expressions and avoid technical terms.
3. At the end of the message, explicitly propose the action: ‘Hung up the phone and consult with your family or public information desk.’

By encoding the output type, tone, and constraints directly into the prompt sentence using structured instructions, server controls the generative AI model's behavior without requiring manual template authoring for each scenario. This improves extensibility and reduces the effort needed to support new conversation patterns.

### G. Generative AI Model Architecture and Training

Server stores a generative AI model implemented as a neural network, for example a decoder-only transformer language model comprising an embedding layer, multiple self-attention layers, and an output projection layer. Server loads model parameters from non-volatile storage into main memory. These parameters have been obtained by pre-training on large text corpora and optionally fine-tuning on domain-specific dialogues involving fraud-related content and assistance behaviors.

Server causes the processor to generate response text by feeding the prompt sentence into the generative AI model and iteratively sampling or selecting next tokens based on probability distributions computed by the model. The model uses learned attention weights to focus on relevant segments of the prompt, including the risk evaluations and emotional state values, thereby enabling context-appropriate generation. During training, model parameters are updated by minimizing a loss function, for example cross-entropy between predicted and true token sequences, using gradient-based optimization. Server (or an external training system) adjusts parameters using methods such as stochastic gradient descent or variants with adaptive learning rates.

By using such a generative AI model with prompt sentences that encoding numeric risk and emotion values, server enables the model to generate responses that adapt to system-level indicators beyond raw text, which is not feasible when humans manually craft static responses. This integration uses the computational capabilities of the neural network to interpolate between many training examples and produce context-sensitive outputs covering unseen combinations of conversation content, risk scores, and emotion states.

### H. Filtering and Verification of Response Text

Server performs filtering on response text generated by the generative AI model. Server compares the response text with a stored list of prohibited expressions, and checks for length limits by counting characters or tokens. Server may also invoke a secondary classifier, such as a text safety model trained to categorize outputs as acceptable or unacceptable.

If server detects a violation, server discards the response and, optionally, regenerates a new response after adjusting the prompt sentence to include stricter instructions, such as explicitly forbidding mention of financial transfers. This loop continues until a response passes the filter or a maximum number of attempts is reached. This automated verification process provides a technical safeguard that reduces the risk of inappropriate or unsafe outputs, something that would be difficult to enforce consistently if human operators manually composed or reviewed all responses in real time.

### I. Presentation of Responses and Adaptive Speech Synthesis

Terminal receives the verified response text, safety level, and recommended actions from the server. Terminal displays the information on the display device, using formatting determined by the safety level, such as changing color schemes or icons to highlight high-risk situations. Terminal also uses a speech synthesis engine to convert the verified response text into audio. Terminal controls parameters of the speech synthesis, such as speaking rate, pitch, and intonation, based on the emotion state vector provided by the server. For example, terminal selects a slower speaking rate and a lower pitch when the anxiety component is high, to produce a calming effect, and may choose a slightly more neutral tone when the user is relatively calm. By mapping numeric emotion values into concrete synthesis parameters through a defined function, terminal achieves fine-grained control over audio output characteristics, thereby improving intelligibility and user comfort compared to fixed-parameter synthesis.

Terminal routes synthesized audio representing questions to the counterpart through the in-call audio path and routes synthesized audio representing explanations to the user through the device's speaker or earpiece. This dual routing uses the communication hardware in a specific manner, controlling which audio streams are sent over the network and which are kept local. This behavior provides a technical effect in that it allows the same generative response to be decomposed and delivered optimally for different recipients without requiring separate calls or connections.

### J. Logging and Model Update Using Action History

Terminal logs actions that the user performs following guidance, such as ending a call, contacting a third party, or disregarding a recommendation. Terminal sends this action history information to the server along with identifiers. Server stores the action history information in a database and associates it with the fraud-risk indicators and emotion state vectors that were present when the guidance was delivered.

Server uses this logged data during model update. For example, when a high fraud-risk indicator was produced and the user ended the call, server can treat this as implicit confirmation of a correct alert, while a case in which the user continued the call and later reported fraud can be used as a false-negative instance. Server re-trains or fine-tunes the classification model and emotion recognition models by including such data in training sets, adjusting parameters to reduce prediction errors. During training, server computes loss values and gradients, and updates network weights according to prescribed learning rules. This closed loop improves performance over time and continues to adapt parameters to new fraud patterns and user behavior.

### K. Technical Effects and Improvement of Computer Technology

Server, by integrating multimodal emotion analysis, fraud-risk modeling, structured prompt sentence generation, and generative AI output filtering, improves the technical operation of the fraud-detection system. Specifically, server reduces latency by sharing tokenized and parsed representations between models, thus avoiding repeated parsing steps, and by fusing scores in a single pass. Server improves detection accuracy by combining learned models with weighted keyword scoring and by fusing audio and text emotion signals. Server also reduces communication load by transmitting compact representations such as feature vectors and text segments instead of raw audio streams in full resolution.

Terminal and server together implement a control loop that adapts speech synthesis parameters and UI presentation based on numeric emotion indices. This processing controls technical components such as audio encoders, synthesis engines, and display modules. The system therefore does more than automate human decision making; it uses internal representations and neural-network outputs to drive concrete changes in device behavior that optimize audio routing, output tone, and timing. This yields measurable improvements in the reliability and usability of communication devices in high-risk scenarios.

Furthermore, by using action history to update models and prompt generation policies, server implements a feedback mechanism that continuously improves the computational efficiency and accuracy of internal models. The system refines threshold values, risk mapping functions, and prompt structures in light of observed user responses, which reduces unnecessary alerts and improves the alignment between generated guidance and user needs. These technical improvements in data management, model updating, and generative control contribute to the overall enhancement of computer-implemented communication safety systems.

### L. Alternative Embodiments and Variations

Server may use different types of machine-learning models for fraud classification and emotion recognition, such as recurrent neural networks, convolutional networks, or hybrid architectures. Server may use alternative fusion methods for combining scores, such as attention-based fusion networks that dynamically weight modalities based on confidence metrics. Terminal may run some models locally, such as a lightweight emotion recognition model, to reduce network latency, while server performs more computationally intensive processing.

Prompt sentence templates may be varied to support additional languages, different politeness levels, or different regulatory contexts. The generative AI model may be replaced with other neural language models conforming to the same input-output interface. The filtering rules may be extended by adding context-sensitive policies, such as stricter constraints for particular user groups.

In each embodiment, server and terminal remain configured to perform concrete processing on audio signals, text representations, and structured indicators, and to control output devices and communication paths in accordance with computed fraud-risk and emotion-state information, such that the system provides improved technical performance as compared to conventional fraud-detection and call-assistance systems.

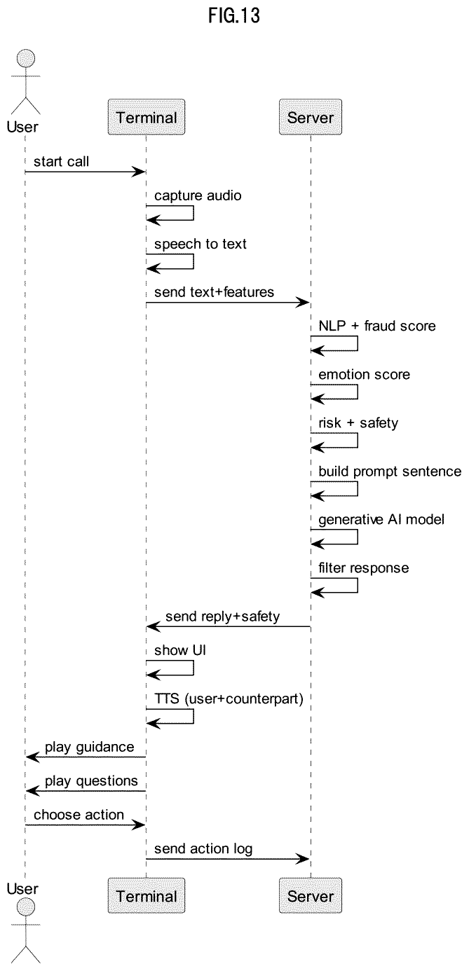

The following describes the processing flow using FIG. 13.

### Step 1:

User initiates or answers a voice call using the terminal.

Input: User operation on the terminal's call interface.

Output: Call start event and call identifier.

Terminal detects the call start event via an operating system telephony API, obtains or generates a unique call identifier, and allocates an internal call session object in memory. Terminal sets flags indicating that monitoring is active for this call and initializes modules for audio capture, local buffering, and communication with the server.

### Step 2:

Terminal captures in-call audio and converts it to framed digital data.

Input: Analog audio signal from the microphone during the call.

Output: Framed digital audio data with timestamps and call identifier.

Terminal uses an audio input API to sample the analog signal at a predetermined sampling rate and bit depth, such as 16 kHz and 16-bit PCM. Terminal groups contiguous samples into frames of fixed duration, for example 0.5 seconds, and assigns a timestamp and the call identifier to each frame. Terminal stores the frames in a ring buffer for further processing.

### Step 3:

Terminal performs speech recognition on the captured audio to generate text.

Input: Framed digital audio data (user and counterpart mixed or separated).

Output: Utterance records containing text, speaker label, start time, and end time.

Terminal passes the audio frames to a speech recognition engine, either a local library or a remote speech recognition service. The engine applies acoustic models and language models to estimate word sequences from the audio waveforms. Terminal groups recognized words into utterances based on silence and segmentation events, labels each utterance as spoken by the user or the counterpart, and records start and end times derived from frame timestamps.

### Step 4:

Terminal extracts acoustic features from user audio for emotion analysis.

Input: Framed digital audio data for user speech.

Output: Acoustic feature vectors and associated timestamps.

Terminal selects frames containing user speech using channel information or voice activity detection. Terminal computes acoustic feature vectors such as Mel-frequency cepstral coefficients, energy, and pitch from each frame by applying Fourier transforms, filter banks, and logarithmic scaling. Terminal normalizes the feature values and attaches timestamps and the call identifier.

### Step 5:

Terminal packages utterances and acoustic features and sends them to the server.

Input: Utterance records and acoustic feature vectors.

Output: Network request containing session data.

Terminal aggregates newly generated utterances and feature vectors into a structured payload, such as a JSON document containing the call identifier, utterance list, and feature list. Terminal opens or reuses a secure network connection to the server and transmits the payload via an application protocol. Terminal marks transmitted items as sent to avoid resending.

### Step 6:

Server receives and stores session data from the terminal.

Input: Network request with call identifier, utterances, and acoustic features.

Output: Updated session record in server memory or storage.

Server parses the incoming request, validates the call identifier, and retrieves or creates a session record. Server appends the new utterances to the conversation history and appends the acoustic feature vectors to an emotion-analysis buffer associated with the session.

### Step 7:

Server performs morphological analysis and tokenization on counterpart text.

Input: Utterance records including counterpart text.

Output: Token sequences with part-of-speech tags.

Server selects counterpart utterances from the conversation history and concatenates them into analysis segments. Server applies a morphological analyzer to segment each segment into tokens and assign part-of-speech and base-form information. Server then applies a tokenizer compatible with a transformer model to convert tokens into subword units and numerical token identifiers.

### Step 8:

Server computes a model-based fraud-risk score from the token sequences.

Input: Token identifiers and attention masks.

Output: Fraud-risk probability and optional fraud category label.

Server constructs model input tensors from the token identifiers and attention masks and feeds them into a trained transformer-based classification model. The model processes the input through multiple self-attention and feed-forward layers to produce contextual embeddings. Server applies a classification head to the embeddings and then a softmax or logistic function to obtain a probability that the text is related to fraudulent activity and, optionally, a category label. Server writes this probability into the session as a model-based fraud-risk score.

### Step 9:

Server computes a keyword-based auxiliary score.

Input: Original counterpart text and a dictionary of dangerous expressions.

Output: Auxiliary score indicating risk based on keyword usage.

Server scans the original text for predefined dangerous expressions using pattern matching. For each matched expression, server increments a count and multiplies the count by a predefined weight associated with the expression. Server sums the weighted counts to obtain an auxiliary score. Server normalizes or caps the auxiliary score to a desired numeric range.

### Step 10:

Server fuses the model-based score and the auxiliary score into a fraud-risk indicator. Input: Model-based fraud-risk score and auxiliary score.

Output: Integrated fraud-risk indicator.

Server applies a fusion function, such as a weighted linear combination followed by normalization, to combine the model-based score and the auxiliary score. The fusion function may assign higher weight to the model-based score under normal conditions and increase the contribution of the auxiliary score when critical patterns appear. Server stores the resulting integrated value as the fraud-risk indicator in the session record.

### Step 11:

Server estimates audio-based emotion scores from acoustic features.

Input: Acoustic feature vectors for user speech.

Output: Audio-based emotion scores for multiple emotion classes.

Server groups feature vectors into sequences suitable for an audio emotion recognition model. Server feeds the sequences into a neural network that processes temporal patterns and produces hidden representations. Server applies an output layer with softmax activation to compute probabilities for emotion classes such as anxiety, confusion, anger, fear, and calmness. Server averages or otherwise aggregates these probabilities over the sequence to generate stable audio-based emotion scores.

### Step 12:

Server estimates text-based emotion scores from user utterances.

Input: User utterance records and associated text.

Output: Text-based emotion scores for multiple emotion classes.

Server selects user utterances and concatenates them into a text segment for analysis. Server tokenizes the text with a tokenizer for a text emotion model and constructs input tensors. Server runs the text emotion model to obtain per-class logits and converts them into probabilities using a softmax function. Server may average probabilities across multiple user segments to obtain text-based emotion scores representing each emotion class.

### Step 13:

Server fuses audio-based and text-based emotion scores into an emotion state vector.

Input: Audio-based emotion scores and text-based emotion scores.

Output: Emotion state vector containing integrated emotion values.

Server aligns the emotion classes from the audio-based and text-based scores and applies a fusion rule, such as weighted averaging or processing through a fusion network. For each emotion dimension, server calculates a combined score and normalizes the values so that they fall within a predetermined range. Server constructs an emotion state vector with components corresponding to these combined scores and stores it in the session record.

### Step 14:

Server determines a safety level and recommended actions.

Input: Fraud-risk indicator and emotion state vector.

Output: Safety level label and list of recommended actions.

Server evaluates rule conditions or a learned mapping that relates the numeric fraud-risk indicator and components of the emotion state vector to safety categories. Server compares values with thresholds and applies decision logic to assign a safety level such as very dangerous, caution required, or relatively safe. Based on the assigned safety level and emotion state, server selects recommended actions, such as ending the call immediately or asking the counterpart additional verification questions, and stores these in the session.

### Step 15:

Server constructs a prompt sentence for the generative AI model.

Input: Conversation history, fraud-risk indicator, safety level, and emotion state vector.

Output: Prompt sentence text containing instructions and context.

Server selects recent utterances from the conversation history and formats them as quoted speech. Server converts the fraud-risk indicator, safety level, and emotion scores into human-readable descriptions. Server inserts this content into a predefined template that specifies the role of the generative AI model, describes the current situation, and defines required output type and style. Server assembles the sections into a single prompt sentence that encodes both context and generation constraints.

### Step 16:

Server generates response text via the generative AI model.

Input: Prompt sentence text.

Output: Response text including questions and explanations.

Server feeds the prompt sentence into the generative AI model and configures generation parameters such as maximum length and sampling strategy. The model computes token probabilities at each step and selects or samples tokens to form output text. Server continues this process until a stop condition, such as reaching an end token or a length limit, is met. Server obtains the final response text string and, if necessary, separates sections intended as questions to the counterpart and explanations for the user.

### Step 17:

Server filters and verifies the generated response text.

Input: Response text from the generative AI model.

Output: Verified response text.

Server checks the response text against a list of prohibited expressions and length constraints. Server scans the text sequentially and compares substrings with prohibited patterns, and calculates character or token counts. If a violation is detected, server may adjust the prompt sentence to add stricter instructions and regenerate the response. When the response text satisfies all constraints, server designates it as verified response text for delivery.

### Step 18:

Server transmits the verified response text, safety level, and recommended actions to the terminal.

Input: Verified response text, safety level, and recommended actions.

Output: Network response containing guidance data for the terminal.

Server packages the verified response text, safety level label, recommended action list, and call identifier into a structured response message. Server sends this message via the network interface using a response channel established with the terminal. Server logs that guidance has been produced for the session.

### Step 19:

Terminal presents guidance visually and prepares for audio output.

Input: Response message containing verified response text, safety level, and recommended actions.

Output: Updated user interface state and audio synthesis requests.

Terminal parses the response message and extracts explanation text, question text, safety level, and recommended actions. Terminal updates the display to show safety information and textual guidance using styling appropriate to the safety level. Terminal prepares text segments for text-to-speech conversion, tagging which segments are intended for the user and which are intended for the counterpart.

### Step 20:

Terminal synthesizes and outputs speech based on the verified response text and emotion state.

Input: Text segments for user and counterpart, emotion state data.

Output: Audio signals routed to the in-call audio path and local speaker.

Terminal calls a speech synthesis engine with the text segments and adjusts parameters such as speaking rate and pitch according to emotion values, for example slowing speech when user anxiety is high. Terminal generates audio signals and routes question audio into the call audio path so the counterpart hears the questions, while routing explanation audio to the local speaker so the user hears the guidance. Terminal monitors user input for operations such as ending the call or disabling automatic speech and updates or stops audio output based on these operations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional security assistance systems that process audio and text suffer from several technical limitations in how they utilize computational resources and how they structure information for downstream models. Many existing systems rely on simple keyword spotting in transcribed text and static rule sets, without integrating acoustic emotion signals or temporal evolution of risk. As a result, the systems often misclassify threats, generate inappropriate automated responses, or require extensive manual tuning. From a computer-technology perspective, these systems typically implement disjoint pipelines: one module performs speech recognition, another performs text classification, and yet another triggers fixed templates, with little or no coordinated use of time-aligned multimodal features. This fragmented architecture leads to inefficient use of processor cycles, redundant data transformations, and increased latency, because each module repeatedly accesses and reprocesses the same underlying conversation data.

Furthermore, when large generative models are used, conventional systems usually pass raw transcripts or unstructured context to such models. Without a structured, machine-optimized prompt, the generative model must internally infer relevant risk factors, emotional states, and context, increasing computational load and inference time and often yielding unstable outputs. The processor is not effectively guided to focus its computation on risk-critical aspects of the data. In addition, conventional systems tend to perform one-shot generation: a single response is generated based on a snapshot of the conversation. There is no systematic mechanism for continuous re-evaluation of multimodal risk indicators and no mechanism for iteratively updating prompts in a way that is synchronized with the temporal progression of the audio stream. This results in poor adaptability to rapidly changing situations and inefficient use of hardware resources, because models may be invoked either too frequently or too late. Moreover, speech synthesis components in conventional systems usually apply static prosody parameters, independent of any structured representation of user emotion. The processor therefore cannot exploit integrated emotion information to dynamically control speaking rate, pitch, volume, and prosody in an optimized manner. This not only degrades user experience, but also wastes computational opportunities to modulate synthesis parameters programmatically based on real-time emotional state, which could reduce the need for repeated, trial-and-error synthesis calls.

Accordingly, there is a need for a computer-implemented security support system in which a processor: (i) jointly exploits acoustic and textual emotion classification results with time alignment, (ii) computes structured, multi-type risk scores based on integrated multimodal features, (iii) programmatically constructs machine-optimized prompt sentences for a generative AI model that explicitly encode conversation summaries, detected categories, emotion states, and threat levels, and (iv) continuously updates such prompt sentences and model outputs in synchronization with the temporal evolution of the underlying data. There is also a need to couple the integrated emotion information directly into the control of speech synthesis parameters, so that the same processor that evaluates risk can dynamically adapt voice output characteristics. By addressing these issues, the invention aims to improve the technical operation of computer systems that perform multimodal security analysis and generative response control, reducing latency, redundant computation, and instability in AI-generated outputs.

The specific processing by the specific processing unit 290 of the data processing device 12 in Application Example 2 is realized by the following means.

The present invention provides a server comprising a processor configured to receive and preprocess an acoustic signal acquired from a terminal, generate character information based on the acoustic signal, perform natural language processing on the character information to detect dangerous expressions and to calculate similarity with past incident information, extract acoustic feature quantities from the acoustic signal and perform emotion classification to calculate first emotion information, perform emotion classification on the character information to calculate second emotion information, integrate the first emotion information and the second emotion information along a time axis and for each speaker to generate integrated emotion information, calculate risk scores relating to a plurality of types of security incident and evaluate a threat level based on an analysis result of the natural language processing and the integrated emotion information, construct a prompt sentence including at least a conversation summary, a detected category, an emotion state, the threat level, and output conditions, based on the analysis result, the integrated emotion information, and the risk scores, cause a generative AI model to generate response information by using the prompt sentence as input, determine speech synthesis parameters based on the response information and the integrated emotion information and convert a text response sentence included in the response information into audio data, and update the prompt sentence and the response information continuously in accordance with temporal transitions of the character information, the integrated emotion information, and the risk scores. This enables the processor to perform a tightly integrated, multimodal security evaluation and response generation workflow in which acoustic and textual emotion features are fused in time, structured risk-aware prompt sentences are programmatically constructed and iteratively refined for a generative AI model, and speech synthesis parameters are dynamically controlled based on real-time integrated emotion information, thereby improving computational efficiency, reducing response latency, and stabilizing the quality and relevance of AI-generated security assistance outputs.

The term “acoustic signal” refers to a time-varying waveform representing sound, including at least human speech, which has been acquired by an input device such as a microphone and converted into a digital format with a predetermined sampling rate and quantization resolution.

The term “terminal” refers to an information processing device operated by a user, including at least a portable information terminal, a mobile communication device, or a stationary communication device, which is configured to acquire the acoustic signal, transmit the acoustic signal to a server, and present responses from the server.

The term “character information” refers to text data obtained by converting the acoustic signal into a sequence of characters or symbols by speech recognition, or by receiving textual input through another input interface, the text data representing natural language content.

The term “natural language processing” refers to information processing applied to the character information, including at least tokenization, syntactic analysis, semantic analysis, classification, and extraction of expressions, in order to detect dangerous expressions, estimate categories, or compute similarity with past incident information.

The term “dangerous expression” refers to a word, phrase, or combination of words included in the character information that has been predetermined as being associated with a security incident, such as an attack, intrusion, explosion, fraud, or other harmful act.

The term “past incident information” refers to data stored in a storage device that represents previously recorded security incidents, including at least natural language descriptions and associated metadata, which are used as reference information for similarity calculation and risk evaluation.

The term “acoustic feature quantity” refers to a numerical parameter computed from the acoustic signal, including at least spectral features, cepstral coefficients, pitch, energy, and temporal rate, which characterize properties of the speech and are used for emotion classification.

The term “emotion classification” refers to processing that assigns one or more emotion categories, such as anger, fear, anxiety, joy, sadness, or neutral, to an input, and outputs at least a probability or intensity value for each emotion category.

The term “first emotion information” refers to information representing an emotion state of a speaker, which is obtained by performing emotion classification on acoustic feature quantities derived from the acoustic signal.

The term “second emotion information” refers to information representing an emotion state inherent in text content, which is obtained by performing emotion classification on the character information.

The term “integrated emotion information” refers to information representing a comprehensive emotion state of each speaker or of an entire conversation, which is obtained by aligning and integrating the first emotion information and the second emotion information along a time axis and per speaker and by applying weighting or temporal smoothing.

The term “risk score” refers to a numerical indicator that represents a likelihood or severity of occurrence of a security incident, such as a violent act, an explosion, an intrusion, or a fraud, the numerical indicator being calculated based on at least an analysis result of the natural language processing and the integrated emotion information.

The term “threat level” refers to a discrete or categorical evaluation, such as low, medium, high, or critical, which is assigned based on one or more risk scores by comparing the risk scores with predetermined thresholds.

The term “prompt sentence” refers to an input text supplied to a generative AI model, the input text including at least a conversation summary, a detected category, an emotion state, a threat level, and output conditions, and serving as a structured instruction that guides generation of response information.

The term “conversation summary” refers to text representing a condensed description of at least part of the conversation contained in the character information, the text including essential facts, participants, and context, and being suitable for inclusion in the prompt sentence.

The term “detected category” refers to a classification label or score indicating a type of security incident, such as explosive-related, violence-related, intrusion-related, or fraud-related, which is derived from the natural language processing performed on the character information.

The term “emotion state” refers to a set of values, including at least one of anger, fear, anxiety, joy, sadness, or calmness, which are derived from the integrated emotion information and indicate an emotional condition of a speaker over a specified time interval. The term “output conditions” refers to constraints and requirements included in the prompt sentence that define at least a target audience, a desired tone, a format, and behavioral constraints for the response generated by the generative AI model.

The term “generative AI model” refers to a machine learning model having a large number of parameters and configured to generate natural language text or other structured outputs in response to an input prompt sentence, by probabilistic decoding based on a learned representation of language.

The term “response information” refers to text or structured data generated by the generative AI model in response to the prompt sentence, the text or structured data including at least instructions, countermeasures, explanations, or reassurance messages to be presented to a user or an operator.

The term “speech synthesis parameters” refers to control values used in a speech synthesis process, including at least a speaking rate, a fundamental frequency, a volume, and prosodic patterns, the control values determining characteristics of generated audio.

The term “text response sentence” refers to a portion of the response information that is expressed as natural language text and is intended to be converted into audio data by a speech synthesis process.

The term “audio data” refers to digital data representing a synthesized sound waveform that has been generated from a text response sentence by a speech synthesis process, and that is suitable for playback through an audio output device.

The term “temporal transitions” refers to changes over time in at least the character information, the integrated emotion information, and the risk scores, which are observed over consecutive time intervals and used to update the prompt sentence and the response information.

In one embodiment, a server, a terminal, and a user cooperate to implement the claimed system. The server executes software components on general-purpose hardware, the terminal provides audio input and output interfaces, and the user operates the terminal in a monitored environment such as a commercial facility, a financial institution, or a transportation hub.

The server includes at least one multi-core central processing unit, at least one hardware accelerator such as a graphics processing unit, a main memory, and a non-volatile storage device such as a semiconductor storage device. The server executes a server-class operating system and runs application software modules including an audio preprocessing module, a speech recognition module, a natural language processing module, an emotion recognition module, a risk evaluation module, a prompt sentence generation module, a generative AI inference module, a speech synthesis module, and a session management module. The server further maintains a relational database or a similar persistent storage structure that stores conversation logs, past incident information, model outputs, and audit trails of prompt sentences and responses.

The terminal includes an input device such as a microphone, an output device such as a loudspeaker and a display, a communication interface, and a processing unit executing a terminal operating system. The terminal executes an application program that controls audio acquisition, data transmission to the server, and presentation of text and audio responses. The terminal may be a handheld communication device, a portable information device, or a fixed monitoring console.

The user operates the terminal to start and stop monitored sessions, selects monitoring areas and languages, and observes audio and text responses. The user may be a security operator, an administrator, or an end-user being protected against fraud or physical threats. In the implemented system, the server receives an acoustic signal acquired by the terminal. The server uses audio processing libraries, such as a general-purpose time-frequency analysis library, to perform a short-time Fourier transform and to construct a time-frequency representation of each segment of the acoustic signal. The server applies a noise estimation algorithm that computes a noise power spectral density over non-speech intervals using minimum statistics or spectral subtraction techniques, and subtracts this estimate from the observed magnitude spectrum. This data operation reduces background noise components before subsequent recognition and classification stages, which in turn reduces error rates in the speech recognition and emotion classification modules.

The server further applies a band-pass filter in the frequency domain, attenuating components outside of a speech-relevant band and amplifying components within the band. The server implements the band-pass filter as a digital filter whose coefficients are stored in a parameter table and are selected based on the sampling rate and expected speaker characteristics. By performing this filtering in the frequency domain, the server reduces computation compared to repeated time-domain convolution and can exploit vectorized operations on the graphics processing unit. This improves processing speed and reduces latency for real-time monitoring. The server converts the preprocessed acoustic signal into character information using a speech recognition model executed on the graphics processing unit. In one embodiment, the server uses a neural network-based speech recognition model that includes an encoder network with convolutional or recurrent layers, an attention mechanism, and a decoder network producing token sequences. The encoder maps sequences of acoustic feature vectors (such as log-mel spectrograms) into high-dimensional hidden representations; the decoder produces textual tokens, which are then mapped to character sequences in the selected language. The server aligns recognition outputs with original time indices and stores them as records in a conversation log table, which contains fields including session identifier, speaker identifier, start and end timestamps, recognized text, and confidence scores.

The server executes a natural language processing module on the character information. The server tokenizes the character information using a subword tokenizer and inputs the token sequence into a pretrained language model whose architecture may be a multi-layer transformer encoder. The language model outputs contextual embeddings for each token. On top of such embeddings, the server applies classification heads implemented as fully-connected layers and softmax functions to obtain scores for security incident categories such as explosive-related, violence-related, intrusion-related, and fraud-related. The server also executes a rule-based dangerous expression detector that applies pattern matching over token sequences using a dictionary of dangerous expressions and grammatical patterns. The server calculates similarity between current character information and past incident information. The server uses a sentence-level embedding model such as a transformer-based encoder that outputs fixed-dimension vectors for each sentence or utterance. The server stores a set of reference embeddings for past incident descriptions in a vector index in persistent storage. For each new utterance, the server computes its embedding vector, executes a nearest-neighbor search using a vector similarity library, and computes cosine similarity values. These similarity values are stored in association with the utterance and are later used as features by the risk evaluation module.

The server performs emotion recognition in a multimodal manner. The server computes acoustic feature quantities from the acoustic signal, such as mel-frequency cepstral coefficients, pitch, energy, and estimated speech rate, using an audio analysis library. The server standardizes these features and feeds them into a trained neural network for speech emotion classification. In one embodiment, the neural network includes a sequence encoder with recurrent or transformer layers and a classification layer that outputs, via a softmax activation function, probabilities for multiple emotion classes. The server stores the resulting probability distributions as first emotion information for each time segment and speaker. The server also performs emotion classification on the character information. The server inputs tokenized text into a transformer encoder and obtains contextual token embeddings. The server aggregates these embeddings, for example by pooling or by using a special classification token, and applies a classification layer that outputs emotion scores for categories such as anger, anxiety, sadness, and calmness. These scores are stored as second emotion information, timestamped and associated with the same timeline as the acoustic segments.

The server generates integrated emotion information by combining the first emotion information and the second emotion information. For each speaker and for each time interval, the server aligns acoustic and textual records and computes a weighted sum or other fusion function that takes into account modality-specific reliability. For example, the server may assign a higher weight to acoustic emotion probabilities when detecting anger and a higher weight to textual emotion probabilities when detecting sadness. The server then applies temporal smoothing, such as an exponential moving average or a low-pass filter, on the fused emotion scores to reduce noise and spurious spikes. The server maintains integrated emotion information in a session-indexed data structure that can be queried efficiently by time window and speaker.

The server calculates risk scores using a risk evaluation model. The server constructs a feature vector for each evaluation time window that includes indicator variables for detected dangerous expressions, classification scores for incident categories, similarity scores to past incident records, contextual features such as imperatives and urgency markers, and integrated emotion scores and their recent changes. The server inputs this feature vector into a trained machine learning model implemented as a gradient boosting model or a neural network with one or more hidden layers. During training, the server uses labeled historical data with known incident outcomes and applies a loss function such as cross-entropy to update model parameters by gradient-based optimization. The server may also apply data augmentation techniques such as noise injection in the acoustic domain or paraphrasing in the textual domain to improve generalization. In deployment, the server executes forward passes of this model to output risk scores for multiple incident types and to assign discrete threat levels by comparing risk scores to stored threshold values.

The server generates a prompt sentence for a generative AI model by assembling structured data into natural language text. The server reads the conversation summary, detected categories, integrated emotion states, risk scores, and threat levels for the current time interval from the stored data structures. The server uses a template-based generator that inserts values into predefined placeholders and produces an instruction text that explicitly specifies the desired output format, tone, and constraints. By encoding structured information into the prompt sentence in a consistent layout, the server allows the generative AI model to focus its computation on relevant features without inferring them from raw transcripts, thereby reducing inference time and improving output stability.

For example, the server may generate a prompt sentence such as:

“You are a generative AI model supporting security operators. Based on the following information, propose the most appropriate response in Japanese.

Conversation summary: ‘Male A repeatedly says “I'm going to blow this up now,” and Male B says “Stop it” to restrain him. The location is estimated to be a food court in a commercial facility.’
Detected category: explosive-related, high risk
Emotion state of Male A: anger 0.88, excitement 0.76, anxiety 0.40
Emotion state of Male B: fear 0.92, confusion 0.65
Current risk level: highest

### Constraints:

Prioritize the safety of surrounding civilians.
Avoid expressions that directly provoke the suspect.

### Output Format:

1. Concrete step-by-step actions that on-site security guards should take.
2. Instructions (in polite Japanese) that the control-room operator should give to the guards.
3. Instructions for automatic operations on surveillance cameras and recording devices.”

In another example, the server may generate a prompt sentence for assisting an anxious user in a suspected fraud scenario:

“You are a conversational AI designed to calm users who feel anxious. Based on the following information, create a voice response message in Japanese that reassures the user. Situation description:
User's utterance (summary): ‘I received a phone call from the bank telling me to verify my account information. They told me to act immediately, and I am anxious.’
Detected incident category: suspected fraud
User's emotion state: anxiety 0.9, fear 0.7, confusion 0.8
Current risk level: high (possible fraud victim)

### Constraints:

Avoid blaming the user or using expressions that excessively increase anxiety.
Use calm and polite language, and propose concrete actions the user should take.

### Output Format:

A message text (in polite Japanese) that should be read aloud to the user.”

The server transmits the prompt sentence to a generative AI model. In one embodiment, the server hosts a large language model that follows a transformer decoder architecture with multiple attention layers and a large number of parameters. The server stores model weights on the graphics processing unit and executes batched inference calls. The server controls generation parameters such as maximum output tokens, temperature, and sampling strategies (for example, top-p sampling) to balance determinism and diversity. The server receives generated text, analyzes the structure based on the requested output format, and separates it into sections corresponding to operator instructions, system control commands, and user messages. The server stores the response information in association with the prompt sentence and the session identifier.

The server also performs speech synthesis for user-oriented text. The server selects speech synthesis parameters according to the integrated emotion information. When the server detects a high anxiety level in the integrated emotion information, the server sets a slower speaking rate, a slightly lower fundamental frequency, a moderate volume, and a smooth prosodic contour. When urgency needs to be conveyed, the server increases speaking rate to a predetermined limit while keeping prosody stable to avoid inducing panic. The server inputs the user-oriented text and the selected parameters into a neural speech synthesis model, such as a sequence-to-sequence model with an encoder-decoder architecture and a neural vocoder. The server generates audio data as a waveform and compresses it if necessary before sending it to the terminal. By coupling the speech synthesis parameters directly to the integrated emotion information, the server reduces the need for repeated synthesis attempts and produces audio that is perceptually appropriate on the first attempt, thereby reducing computation. The terminal receives the audio data and corresponding text and presents them to the user through the loudspeaker and display. The user can immediately act on the guidance, such as directing physical security agents, controlling network connections, or terminating a suspicious call. Because the system continuously updates prompt sentences and response information based on temporal transitions of character information, integrated emotion information, and risk scores, the user receives updated instructions as the situation evolves. The system improves computer technology in several ways. By integrating acoustic and textual emotion signals in a time-aligned manner and using them as input to a risk evaluation model, the server reduces the number of false positives and false negatives without requiring manual rule tuning. The server minimizes redundant data access by maintaining centralized, time-indexed data structures for conversation logs, emotion states, and risk scores, so that each module reads and writes only the necessary information. The server's use of noise reduction and band-pass filtering in the frequency domain reduces computational overhead per frame on the graphics processing unit, enabling lower-latency processing of high-volume audio streams. The programmatic construction of structured prompt sentences concentrates relevant features into a compact text representation, which reduces the number of tokens processed by the generative AI model and thereby reduces inference time and memory consumption.

The system also deviates from simple automation of human tasks by employing machine-oriented data flows and rules that have no direct analogy in human reasoning. For example, the server fuses first emotion information and second emotion information with modality-specific weights derived from cross-validation experiments, applies temporal filtering to suppress high-frequency noise in emotion trajectories, and uses these fused trajectories as numeric features in a risk model that has been trained with gradient-based optimization. The decision to trigger escalation or de-escalation prompt sentences depends on numerical thresholds over derivatives of risk and emotion scores, rather than on human-interpretable discrete events. These non-conventional, algorithmically defined steps produce a quantifiable improvement in detection accuracy and response stability compared to naive rule-based systems.

In alternative embodiments, the server may employ different neural network architectures for speech recognition, emotion recognition, risk evaluation, and generative modeling, as long as these components are configured to generate character information, first emotion information, second emotion information, integrated emotion information, risk scores, prompt sentences, and response information in the manner described. The server may also vary the layout and content of the prompt sentences, for example by including additional context such as camera identifiers or location coordinates, or by adjusting output conditions for different types of terminals. The terminal may be implemented as a fixed kiosk, a vehicle-mounted device, or a wearable device, as long as it includes an audio input, an audio output, and a communication interface.

In further embodiments, the server may distribute parts of the processing pipeline to edge devices closer to the audio source in order to reduce network load. For example, the terminal may perform initial noise suppression or low-bitrate encoding before sending the acoustic signal. The server may also compress intermediate data structures, such as emotion trajectories and risk histories, to reduce storage consumption while still retaining sufficient resolution for continuous evaluation. These variations still follow the core concept that the server integrates multimodal analysis and structured prompt generation to control a generative AI model and a speech synthesis module, thereby improving the efficiency, accuracy, and responsiveness of a computer-implemented security support system.

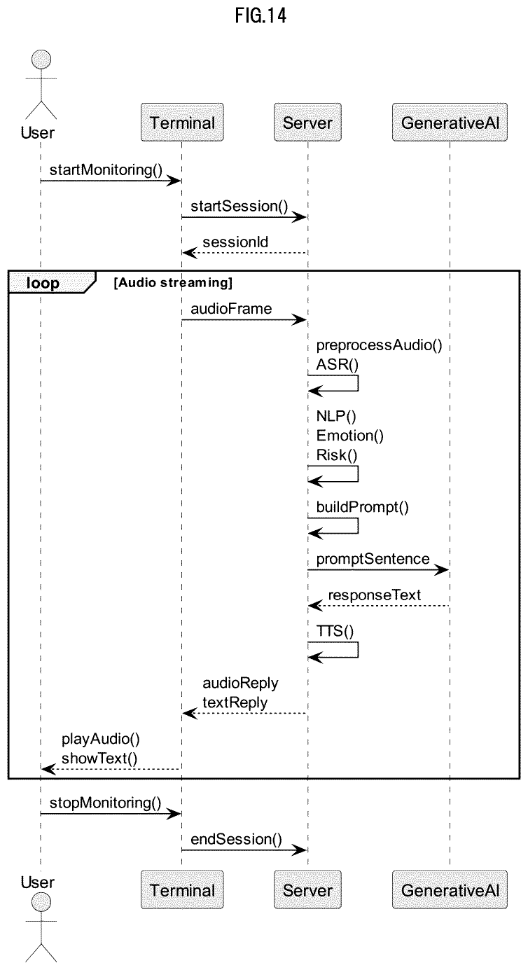

The following describes the processing flow using FIG. 14.

### Step 1:

User operates the terminal to start a monitoring session.

User selects a monitoring area and a language on a graphical user interface of the terminal and presses a “Start” control. This operation is the input to the terminal application.

Terminal uses this input to generate session start data including at least a terminal identifier, a user identifier, a selected area identifier, and a language code, and outputs this data as a session start request message to the server via a communication interface.

### Step 2:

Server receives the session start request message.

Server uses the request message as input and parses its fields to obtain the terminal identifier, the user identifier, the monitoring area, and the language. Server performs a data operation that generates a new session identifier using a unique-ID generation function, creates a session record in a session management table of a database, and allocates log storage regions for audio, text, emotion, and risk data.

Server outputs a session start response message including the session identifier and configuration parameters (such as audio frame length and maximum session duration) and sends this message back to the terminal.

### Step 3:

Terminal begins acquisition of an acoustic signal.

Terminal receives the session start response as input, extracts the session identifier, and configures an audio capture module with the given parameters. Terminal activates a microphone using an operating system audio API and samples the acoustic signal at a specified sampling frequency and bit depth. Terminal segments the continuous stream into fixed-length frames, each associated with the session identifier and a timestamp, and optionally applies compression.

Terminal outputs each audio frame as an audio frame message and transmits these messages to the server via a communication channel.

### Step 4:

Server performs audio reception and buffering.

Server receives the audio frame messages as input through a network endpoint. Server validates the session identifier, decodes compressed audio if necessary, and performs a data operation that stores the audio frames in a temporary audio buffer or an audio frame table in storage, indexed by session identifier and timestamp.

Server outputs buffered audio frame records that are ready for audio preprocessing.

### Step 5:

Server executes audio preprocessing to reduce noise and enhance speech bands. Server takes buffered audio frame records as input and loads the corresponding waveform data into memory. Server performs a short-time Fourier transform to convert each frame from a time-domain waveform into a magnitude-phase spectrum. Server applies a noise estimation algorithm to calculate a noise power spectral density and subtracts this from the magnitude spectrum to obtain a denoised spectrum. Server further multiplies the spectrum by a band-pass filter mask to attenuate frequencies outside a speech band and reinforce speech-relevant frequencies.

Server performs an inverse Fourier transform or equivalent reconstruction to output preprocessed audio frames with reduced noise and enhanced speech components, storing these as preprocessed audio records associated with the original timestamps.

### Step 6:

Server converts the preprocessed audio into character information by speech recognition.

Server uses the preprocessed audio records as input and feeds the corresponding waveforms into a speech recognition engine. The engine extracts acoustic features, applies an encoder-decoder neural network with attention, and performs a decoding algorithm to output token sequences representing linguistic units. Server converts these token sequences into textual strings according to the selected language and aligns them with frame timestamps. Server outputs conversation log entries containing the session identifier, speaker information if available, timing information, recognized text as character information, and confidence scores, and stores these entries in a conversation log table.

### Step 7:

Server applies natural language processing to the character information.

Server retrieves newly generated conversation log entries as input. Server tokenizes each sentence into subword units and applies a transformer-based language model to compute contextual token embeddings. Server performs data operations using classification layers to output incident category probabilities and extracts dangerous expressions by matching tokens and token sequences against a stored dictionary and pattern rules. Server also computes sentence embeddings and performs similarity calculations between current embeddings and stored embeddings of past incident descriptions using cosine similarity.

Server outputs structured text analysis records including detected dangerous expressions, incident category scores, similarity scores to past incidents, and contextual abnormality indices, and stores these records with references to the corresponding conversation log entries.

### Step 8:

Server computes first emotion information from the acoustic signal.

Server uses the preprocessed audio frames as input and extracts acoustic feature quantities such as mel-frequency cepstral coefficients, pitch contours, energy levels, and temporal rates. Server normalizes these features and feeds them into a trained speech emotion classification neural network that outputs, for each time segment and speaker, probability values for multiple emotion categories.

Server outputs first emotion information records containing emotion probability distributions aligned to time segments and speakers.

### Step 9:

Server computes second emotion information from the character information.

Server uses the character information from the conversation log as input and tokenizes each utterance. Server passes the token sequences through a text emotion classification model that computes contextual embeddings and applies a classification layer to produce emotion scores for categories such as anger, anxiety, sadness, and calmness.

Server outputs second emotion information records that include emotion scores for each utterance, referenced by session identifier, time, and speaker.

### Step 10:

Server generates integrated emotion information by fusing first and second emotion information.

Server takes first emotion information and second emotion information as input and aligns them in time for each speaker. Server performs a data operation that applies a fusion function, such as a weighted average or a learned fusion mapping, to combine acoustic-based and text-based emotion scores for each emotion category. Server then applies temporal smoothing operations, such as exponential moving averages, to reduce rapid fluctuations. Server outputs integrated emotion information records for each speaker and time interval, representing stable emotion trajectories, and stores them in an emotion history data structure.

### Step 11:

Server calculates risk scores and evaluates threat levels.

Server uses text analysis records and integrated emotion information as input within a defined time window. Server constructs feature vectors containing indicator variables for dangerous expressions, incident category scores, similarity scores to past incidents, contextual abnormality indices, and integrated emotion scores and their rate of change. Server feeds these feature vectors into a trained risk evaluation model, which executes matrix multiplications and activation functions to compute output values corresponding to risk scores for multiple incident types. Server compares risk scores to threshold values to assign discrete threat levels such as low, medium, high, or critical.

Server outputs risk evaluation records containing per-type risk scores and threat levels and stores them in a risk history table.

### Step 12:

Server constructs a prompt sentence for a generative AI model.

Server uses the conversation summary, detected categories, integrated emotion information, risk scores, and threat levels as input. Server performs a summarization operation on the conversation log to generate a concise text summary, selects the highest-risk incident category, and extracts representative emotion scores for each speaker. Server then fills a prompt template with these values, together with output conditions and constraints that specify audience, tone, and desired output structure.

Server outputs a prompt sentence as a natural language text string that encapsulates the security context, emotion states, and risk assessment in a structured form.

### Step 13:

Server generates response information by using the generative AI model.

Server uses the prompt sentence as input to a generative AI model. Server sends the prompt sentence to a transformer-based language generation network, sets decoding parameters such as maximum length and sampling strategy, and executes forward passes through attention and feed-forward layers to compute token probability distributions. Server iteratively selects tokens based on the probabilities and forms output text that follows the requested output format. Server analyzes the generated text and separates it into segments such as operator instructions, system control directives, and user-oriented messages.

Server outputs response information records that contain these text segments with associated metadata and stores them for subsequent presentation.

### Step 14:

Server determines speech synthesis parameters based on response information and integrated emotion information.

Server uses the user-oriented message text and the integrated emotion information as input. Server inspects the emotion state values, particularly anxiety and fear scores, and performs a data operation that maps these scores to speech synthesis parameters such as speaking rate, fundamental frequency range, volume level, and prosodic contour parameters. Server selects an appropriate voice profile and packages the text and parameters for input to a neural speech synthesis engine.

Server outputs a synthesis request containing the text response sentence and the calculated speech synthesis parameters.

### Step 15:

Server generates audio data from the text response sentence.

Server uses the synthesis request as input and passes the text and parameters into a speech synthesis model. The model converts text into an intermediate acoustic representation using an encoder-decoder network and then applies a neural vocoder to generate waveform samples. Server may apply compression encoding to the waveform for transmission efficiency. Server outputs audio data corresponding to the user-oriented response and packages it together with the original text as an audio-response message sent to the terminal.

### Step 16:

Terminal presents the response information to the user.

Terminal receives the audio-response message as input and decodes the audio data into a playable waveform format using a media codec. Terminal plays the waveform through a loudspeaker and simultaneously displays the corresponding text on a display screen. Terminal outputs sensory signals (sound and visual text) to the user, enabling the user to perceive the guidance and act accordingly in the monitored environment.

### Step 17:

Server updates prompt sentences and response information based on temporal transitions. Server uses sequences of character information, integrated emotion information, and risk history records as input over successive time windows. Server computes differences and trends in risk scores and emotion states and applies decision logic to determine whether escalation or de-escalation is required. When conditions for escalation or de-escalation are met, server constructs updated prompt sentences that request stronger countermeasures or reassurance messages, respectively, by modifying the conversation summary, threat description, and output conditions.

Server outputs new prompt sentences and triggers repeated execution of response generation and speech synthesis, thereby providing updated response information to the user as the situation evolves.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

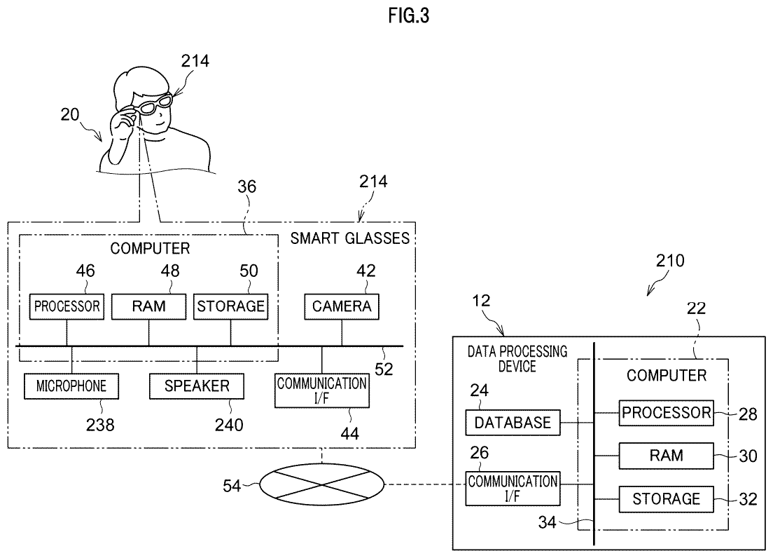

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

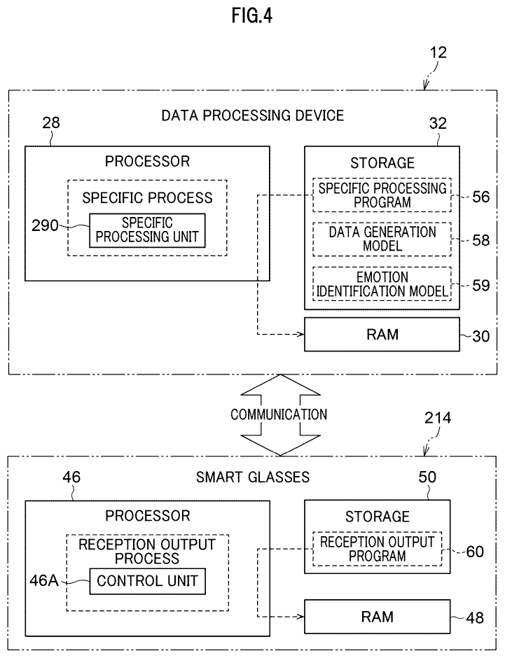

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above. Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

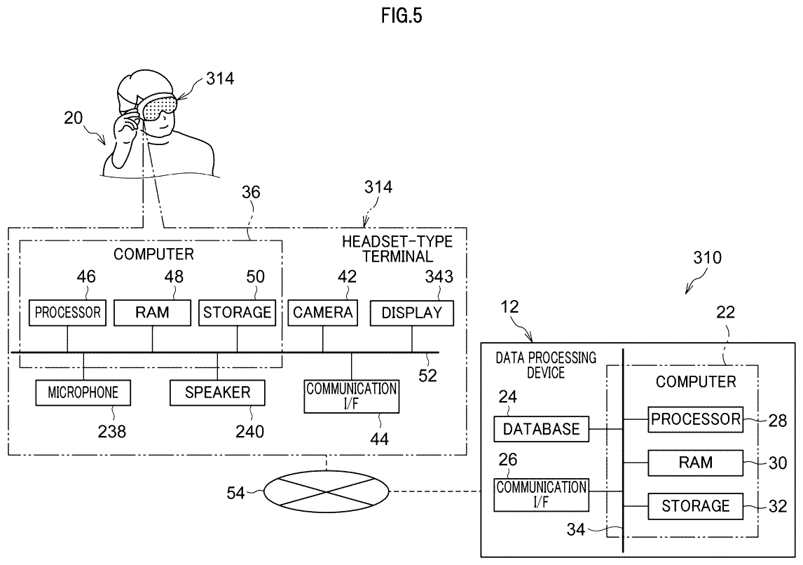

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

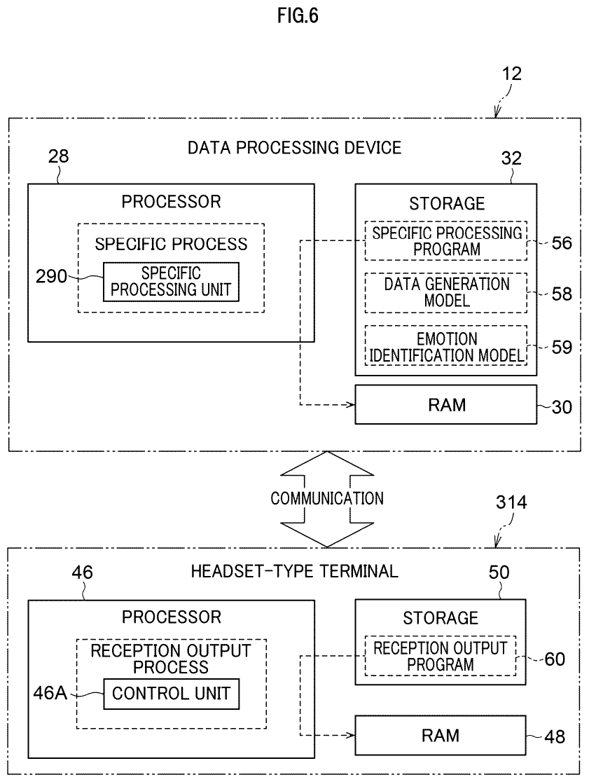

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above. Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

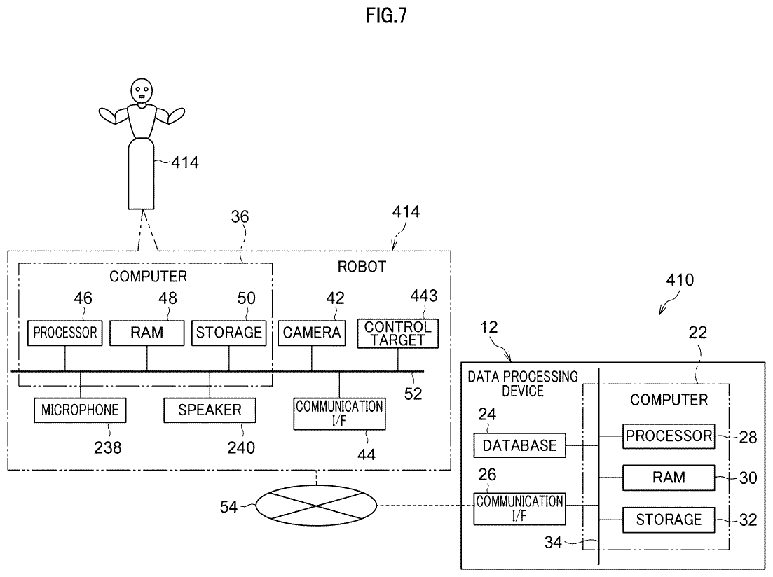

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

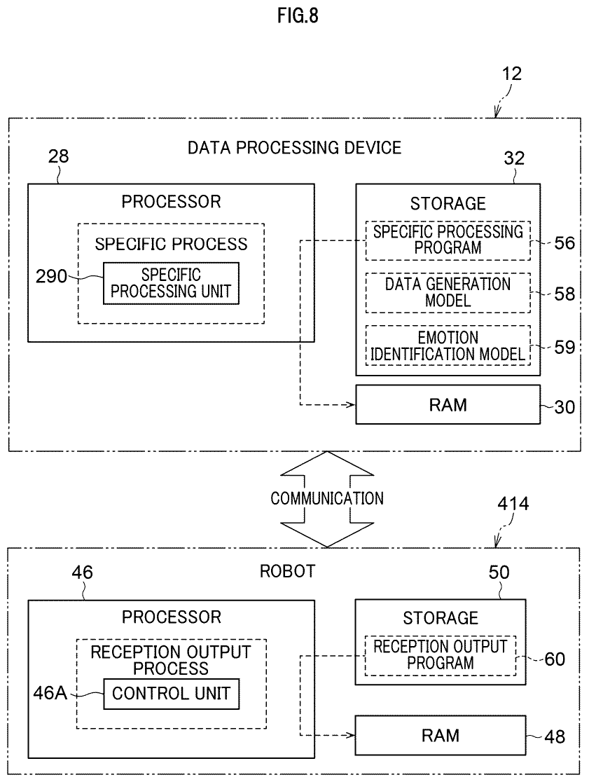

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

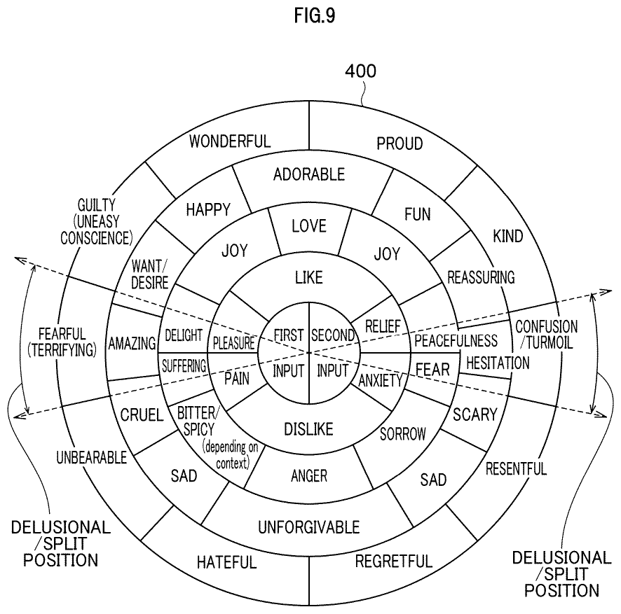

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

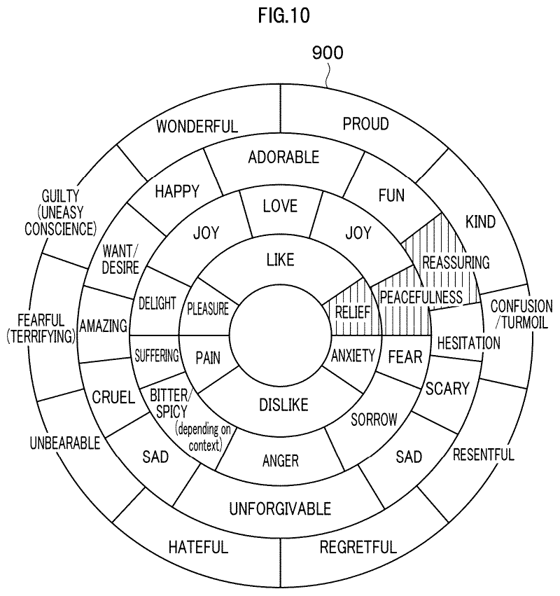

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire audio information at a user terminal, convert the acquired audio information into character string information by performing speech recognition processing, generate text information including the character string information, time information corresponding to the character string information, and speaker classification information, and transmit the text information via a communication path,
receive the text information, perform natural language processing on the text information to execute preprocessing, segmentation into lexical units or subword units, extraction of structural information and pragmatic information, and generation of feature information including an expression related to a fraudulent act from the text information, generate, on the basis of the feature information, a fraud risk index by using a machine learning model, generate an embedding vector corresponding to the text information, execute similarity search on storage means storing fraud case information by using the embedding vector, and update the fraud risk index on the basis of a search result,
generate, on the basis of the text information, the fraud risk index, and the feature information, a prompt sentence to be input to a generative information processing model, input the prompt sentence to the generative information processing model, generate response text for confirmation of an intention of a counterpart party or additional evaluation of fraud risk on the basis of output text obtained from the generative information processing model, transmit the response text and the fraud risk index to the user terminal, and enable the response text to be used at the user terminal as presentation to a user or as a proxy response in a communication,
sequentially update the fraud risk index in response to additional reception of the text information, and dynamically change content or manner of the prompt sentence and the response text according to the updated fraud risk index,
when the fraud risk index exceeds a predetermined threshold, transmit warning information to the user terminal and enable control, at the user terminal, of continuation or interruption of the communication, and
when the fraud risk index satisfies a predetermined low-risk condition, transmit summary information of the communication and final safety evaluation information to the user terminal.

### (Supplementary 2)

The system according to supplementary 1,
wherein the processor is configured to cause the user terminal to convert the response text into audio information by performing speech synthesis processing, output the audio information as communication audio output, and control audio output such that, on the basis of a voice characteristic of the user or a predetermined voice profile, prosody and speaking rate are controlled while a defensive level of response content is changed according to the fraud risk index.

### (Supplementary 3)

The system according to supplementary 1,
wherein the processor is configured to include, in the prompt sentence to be input to the generative information processing model, at least summary information of a plurality of utterances based on a communication history, the fraud risk index, summary information of past fraud cases obtained by the similarity search, and a response generation policy, and to cause the generative information processing model to generate, as the response text, content including a follow-up question, a legitimacy confirmation item, and a personal information non-disclosure policy adapted to reduction of fraud risk.

### Application Example 1

### (Supplementary 1)

A system comprising a processor,
wherein the processor is configured to
acquire and preprocess audio information,
convert the audio information into text information and analyze the text information, evaluate presence and degree of a threat based on a result of the analysis, and update a safety index continuously,
construct a prompt sentence for a generative AI model based on the result of the analysis and the safety index, the prompt sentence including instruction information indicating a response policy to the threat, and input the prompt sentence into the generative AI model to generate response information,
determine response content to be presented to a user or a communication partner based on the response information, and control output of the response content as the text information and as audio information, and
store the result of the analysis, the response information, and past case information, and update, in a learning manner, the threat evaluation and a configuration of the prompt sentence based on the stored information.

### (Supplementary 2)

The system according to supplementary 1,
wherein the processor is configured to
generate the audio information by an audio synthesis process from the response content, perform a dialogue with the communication partner via a communication medium, and
control display of operation items selectable by the user corresponding to action instructions included in the response information output from the generative AI model.

### (Supplementary 3)

The system according to supplementary 1,
wherein the processor is configured to
change components of the prompt sentence in accordance with the threat evaluation and an update of the safety index, dynamically adjust a content and a level of detail of the response information obtained from the generative AI model, output warning information when the safety index exceeds a predetermined threshold, and notify the user of a summary and an evaluation result of an interaction when the safety index is determined to be below a predetermined threshold.

### Example 2

### (Supplementary 1)

A system comprising a processor,
wherein the processor is configured to
receive, from a communication terminal, audio information corresponding to a communication session, convert the audio information into text information by using speech recognition, associate the text information with identification information of the communication session, and store the text information and the identification information,
perform natural language processing on the text information, the natural language processing including morphological analysis and keyword detection, calculate a fraud risk indicator indicating a probability that the text information is related to fraudulent activity by using a classification model based on machine learning and an auxiliary score based on a dictionary of dangerous expressions, and store the fraud risk indicator in association with the identification information,
extract acoustic feature quantities from the audio information related to a user, input the acoustic feature quantities into an audio emotion recognition model to calculate audio-based emotion scores, input the text information related to the user into a text emotion analysis model to calculate text-based emotion scores, and integrate the audio-based emotion scores and the text-based emotion scores to generate an emotion state vector representing an emotional state of the user,
determine, on the basis of the fraud risk indicator and the emotion state vector, a safety level for the communication session and recommended actions to be presented to the user, and store the safety level and the recommended actions in association with the identification information,
generate a prompt sentence for a generative AI model on the basis of at least the text information, the fraud risk indicator, the safety level, the emotion state vector, and a conversation history, the prompt sentence explicitly describing a current risk situation, the emotional state of the user, and a type and expression conditions of a response to be generated,
input the prompt sentence into the generative AI model, obtain from the generative AI model a response text including at least one question text directed to a counterpart and at least one explanation text directed to the user, perform filtering on the response text including checking for prohibited expressions and length limitations, and generate a verified response text, and transmit the verified response text, the safety level, and the recommended actions to the communication terminal so that the communication terminal presents, by at least one of a display device and a voice output device, guidance to the user and the counterpart and operation instructions concerning continuation or termination of the communication session, and
collect action history information indicating actions executed by the user based on the guidance, including at least call termination and contact to a third party, and store the action history information in association with the fraud risk indicator and the emotion state vector.

### (Supplementary 2)

The system according to supplementary 1,
wherein the processor is configured to
cause the communication terminal to input, into a speech synthesis engine, the verified response text including the question text directed to the counterpart and the explanation text directed to the user, generate synthesized speech, control at least one of speaking rate, pitch, and intonation of the synthesized speech on the basis of components of the emotion state vector representing the emotional state of the user, output the synthesized speech related to the question text to the counterpart through an audio path of the communication session as an agent response, and output the synthesized speech related to the explanation text to the user through a built-in audio output device of the communication terminal to notify the user of the safety level and the recommended actions.

### (Supplementary 3)

The system according to supplementary 1,
wherein the processor is configured to
use the action history information as training data to update at least one of the classification model used to calculate the fraud risk indicator and an emotion recognition model used to calculate the emotion state vector, and, based on an updated model, adjust, in a continuous manner, a generation policy of the prompt sentence and the response text by the generative AI model.

### Application Example 2

### (Supplementary 1)

A system comprising a processor,
wherein the processor is configured to
receive and preprocess an acoustic signal acquired from a terminal,
generate character information based on the acoustic signal,
perform natural language processing on the character information to detect dangerous expressions and to calculate similarity with past incident information,
extract acoustic feature quantities from the acoustic signal and perform emotion classification to calculate first emotion information,
perform emotion classification on the character information to calculate second emotion information,
integrate the first emotion information and the second emotion information along a time axis and for each speaker to generate integrated emotion information,
calculate risk scores relating to a plurality of types of security incident and evaluate a threat level based on an analysis result of the natural language processing and the integrated emotion information,
construct a prompt sentence including at least a conversation summary, a detected category, an emotion state, the threat level, and output conditions, based on the analysis result, the integrated emotion information, and the risk scores,
cause a generative AI model to generate response information by using the prompt sentence as input,
determine speech synthesis parameters based on the response information and the integrated emotion information, and convert a text response sentence included in the response information into audio data, and
update the prompt sentence and the response information continuously in accordance with temporal transitions of the character information, the integrated emotion information, and the risk scores.

### (Supplementary 2)

The system according to supplementary 1,
wherein the processor is configured to
set, as the speech synthesis parameters, at least a speaking rate, a fundamental frequency, a volume, and prosody in accordance with the integrated emotion information such that, when an anxiety degree or a fear degree of a user is high, an audio output provides a sense of reassurance, and output, in real time, an audio signal corresponding to a user-oriented explanation sentence included in the response information.

### (Supplementary 3)

The system according to supplementary 1,
wherein the processor is configured to
re-evaluate the risk scores and the integrated emotion information for each predetermined time window, generate, when the risk scores increase, a prompt sentence that instructs generation of strengthened countermeasures including at least an evacuation instruction or a communication interruption, generate, when the risk scores decrease and a safe state is determined, a prompt sentence that instructs generation of a reassurance message, cause the generative AI model to generate the response information based on each of the prompt sentences, and notify the user of the response information.

What is claimed is:

1. A system comprising:
circuitry configured to:
receive, via a communication interface coupled to a packet-switched network, audio data of a voice communication session from a terminal device and convert the audio data into text data using a speech recognition model;
analyze the text data using a natural language processing model to detect keywords or phrases indicating a possibility of fraudulent communication;
compare the text data with stored case records and compute a risk score based on a result of the comparison; and
generate, based on a result of the analysis, response text for probing the possibility of fraudulent communication, and transmit the response text to the terminal device via the communication interface as a proposed response or as an automated agent response.

2. The system according to claim 1, wherein the circuitry receives the audio data in real time during an ongoing voice communication session, and converts the audio data into the text data including character string information, timestamp information for each utterance, and speaker classification information identifying whether each utterance originates from a user or a counterpart.

3. The system according to claim 2, wherein the circuitry performs preprocessing on the text data including segmentation into lexical units, extraction of structural information including sentence boundaries and clause dependencies, and extraction of pragmatic information including urgency indicators and imperative constructions.

4. The system according to claim 3, wherein the circuitry generates feature information from the preprocessed text data including expression patterns associated with fraudulent communication techniques, and classifies the detected expression patterns into categories including impersonation expressions, urgency-inducing expressions, and information-solicitation expressions.

5. The system according to claim 4, wherein the circuitry further extracts prosodic features from the audio data including speech rate variations, pitch anomalies, and hesitation patterns, and incorporates the prosodic features into the feature information as supplemental risk indicators.

6. The system according to claim 1, wherein the circuitry computes the risk score using a machine learning classification model trained on the stored case records, each stored case record including text data of a past communication session, a verified fraud classification, and associated feature information.

7. The system according to claim 6, wherein the circuitry generates an embedding vector from the text data using a neural network encoder, executes a similarity search against embedding vectors of the stored case records, and adjusts the risk score based on similarity distances to case records having verified fraud classifications.

8. The system according to claim 7, wherein the circuitry sequentially updates the risk score in response to additional text data corresponding to subsequent utterances in the voice communication session, and stores a time-series record of risk score values associated with the session in a storage device coupled to the packet-switched network.

9. The system according to claim 1, wherein the circuitry constructs a prompt data structure encoding the text data, the risk score, detected feature information, and conversation history of the voice communication session, transmits the prompt data structure to a generative neural network model comprising a transformer-based architecture with a plurality of self-attention layers, and receives the response text from the generative neural network model.

10. The system according to claim 9, wherein the response text includes questions designed to confirm an intention of a counterpart and additional confirmation items structured to probe the possibility of fraudulent communication without alerting the counterpart.

11. The system according to claim 10, wherein the circuitry dynamically adjusts content of the prompt data structure based on the sequentially updated risk score, increasing a directness of probing questions in the response text as the risk score increases and shifting to reassurance content as the risk score decreases.

12. The system according to claim 1, wherein the circuitry converts the response text into synthesized audio data using a speech synthesis model and transmits the synthesized audio data to the terminal device for playback to a counterpart as the automated agent response during the voice communication session.

13. The system according to claim 12, wherein the circuitry adjusts parameters of the speech synthesis model including speech rate, pitch, and intonation to match voice characteristics extracted from previous utterances of the user, so that the synthesized audio data does not give an unnatural impression to the counterpart.

14. The system according to claim 1, wherein the circuitry transmits warning information to the terminal device when the risk score exceeds a first threshold, enabling the terminal device to display a visual warning and to control continuation or interruption of the voice communication session.

15. The system according to claim 14, wherein the circuitry transmits summary information of the voice communication session and a final safety evaluation to the terminal device when the risk score satisfies a low-risk condition after the voice communication session concludes, and stores the text data, the risk score time-series, and the final safety evaluation as a new case record in the stored case records.

16. The system according to claim 1, wherein the circuitry is further configured to receive feedback data from the terminal device indicating whether the voice communication session was confirmed as fraudulent or legitimate, and to retrain the machine learning classification model using the feedback data and the associated text data.

17. The system according to claim 16, wherein the circuitry estimates an anxiety level of the user based on at least one of voice tremor characteristics extracted from the audio data and interaction timing patterns received from the terminal device, and adjusts a presentation format of the response text transmitted to the terminal device based on the estimated anxiety level, including providing simplified and calming language when the estimated anxiety level exceeds a threshold.

18. A system comprising:
a communication interface including a network interface controller coupled to a packet-switched network and configured to transmit and receive data packets;
a memory storing instructions, a speech recognition model, a natural language processing model, a machine learning classification model trained on stored case records, a generative neural network model comprising a transformer architecture with a plurality of self-attention layers, and a speech synthesis model; and
circuitry comprising one or more processors coupled to the memory and configured to execute the instructions to:
receive, via the communication interface, audio data of a voice communication session from a terminal device and convert the audio data into text data using the speech recognition model;
analyze the text data using the natural language processing model to detect keywords or phrases indicating a possibility of fraudulent communication and to extract feature information;
compute a risk score using the machine learning classification model based on the feature information, generate an embedding vector from the text data, and execute a similarity search against the stored case records to update the risk score;
construct a prompt data structure encoding the text data, the risk score, and conversation history, transmit the prompt data structure to the generative neural network model, and receive response text;
transmit the response text and the risk score to the terminal device via the communication interface;
sequentially update the risk score in response to additional text data and dynamically adjust the prompt data structure based on the updated risk score; and
transmit warning information to the terminal device when the risk score exceeds a threshold.

19. The system according to claim 18, wherein the circuitry is further configured to estimate an anxiety level of the user based on voice characteristics extracted from the audio data, and to adjust a presentation format of the response text based on the estimated anxiety level.

20. A method performed by circuitry of a server coupled to a packet-switched network via a communication interface, the method comprising:
receiving, via the communication interface, audio data of a voice communication session from a terminal device and converting the audio data into text data using a speech recognition model;
analyzing the text data using a natural language processing model to detect keywords or phrases indicating a possibility of fraudulent communication;
comparing the text data with stored case records and computing a risk score based on a result of the comparison; and
generating, based on a result of the analysis, response text for probing the possibility of fraudulent communication, and transmitting the response text to the terminal device via the communication interface as a proposed response or as an automated agent response.
